(19) United States
(12) Patent Application Publication
(10) Pub. No.: US 2019/0138974 A1
(43) Pub. Date: May 9, 2019

(54) SYSTEMS AND DEVICES FOR PARCEL TRANSPORTATION MANAGEMENT

(71) Applicant: Sunago Systems, Inc., Gresham, OR (US)

(72) Inventors: G. Scott Knight, Redmond, OR (US); David Vediner, Gladstone, OR (US)

(21) Appl. No.: 16/153,612

(22) Filed: Oct. 5, 2018

Related U.S. Application Data
(60) Provisional application No. 62/560,111, filed on Sep. 18, 2017.

(51) Int. Cl. G06Q 10/08; G06N 7/00; G06N 20/00; G06Q 10/06

(52) U.S. Cl. CPC G06Q 10/083; G06Q 10/0635; G06N 20/00; G06N 7/005

(57) ABSTRACT

Subject matter disclosed herein may relate to storage and/or processing of signals and/or states representative of parcel transportation management content in a computing device.

Reference is hereby made to a Computer Program Listing Appendix, submitted herewith via compact disc in accordance with 37 C.F.R. § 1.96(c), incorporated herein by reference in its entirety.

### BACKGROUND

### Field

Subject matter disclosed herein may relate to systems and/or devices for parcel transportation management.

### INFORMATION

Integrated circuit devices, such as processors, for example, may be found in a wide range of electronic device types. For example, one or more processors may be used in computing devices, such as, for example, cellular telephones, desktop computing devices, tablet devices, laptop and/or notebook computing devices, digital cameras, server computing devices, personal digital assistants, wearable devices, etc. Such computing devices may include integrated circuit devices, such as processors, for example, to process signals and/or states representative of diverse content types for a wide variety of purposes. With an abundance of diverse content being accessible, signal and/or state processing techniques continue to evolve.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is an illustration depicting an example system and/or device for parcel transportation management, in accordance with an embodiment.

FIG. 2 is an illustration depicting an example process for parcel transportation management, in accordance with an embodiment.

FIG. 3 is a schematic block diagram of an example computing device, in accordance with an embodiment.

FIG. 4 is an illustration of an example device, system, and/or process for processing signals and/or states representative of weather and/or shipping content, in accordance with an embodiment.

FIG. 5 is an illustration depicting an example process for reducing a number of parameters in a set of weather content, in accordance with an embodiment.

FIG. 6 is an illustration depicting an example process for grouping weather content records, in accordance with an embodiment.

FIG. 7 is an illustration depicting an example process for generating values for missing weather content parameters, in accordance with an embodiment.

FIG. 8 is an illustration depicting an example process for linking weather observation records with parcel activity records, in accordance with an embodiment.

FIG. 9 is an illustration depicting an example client portal display, in accordance with an embodiment.

FIG. 10 is an illustration depicting a plot of an example receiver operating characteristic (ROC) curve for example training content, in accordance with an embodiment.

FIG. 11 is an illustration depicting an plot of an example ROC curve for example test content, in accordance with an embodiment.

FIG. 12 is an illustration depicting an example plot of an example decision tree, in accordance with an embodiment.

FIG. 13 is an illustration depicting a plot of an example decision tree ROC curve for example training content, in accordance with an embodiment.

FIG. 14 is an illustration depicting a plot of an example decision tree ROC curve for example test content, in accordance with an embodiment.

FIG. 15 is an illustration depicting an example complexity plot of for an example decision tree, in accordance with an embodiment.

FIG. 16 is an illustration depicting an example complexity plot of for an example pruned decision tree, in accordance with an embodiment.

FIG. 17 is an illustration depicting an example plot of an example pruned decision tree, in accordance with an embodiment.

FIG. 18 is an illustration depicting a plot of an example pruned decision tree ROC curve for example training content, in accordance with an embodiment.

FIG. 19 is an illustration depicting a plot of an example pruned decision tree ROC curve for example test content, in accordance with an embodiment.

FIG. 20 is an illustration depicting a plot of an example random forest ROC curve for example training content, in accordance with an embodiment.

FIG. 21 is an illustration depicting a plot of an example random forest ROC curve for example test content, in accordance with an embodiment.

FIG. 22 is an illustration depicting a plot of an example random forest ROC curve for example content, in accordance with an embodiment.

FIG. 23 is an illustration depicting an example plot of false positive rate vs. false negative rate for an example random forest algorithm, in accordance with an embodiment.

FIG. 24 is an illustration of an example scatter plot depicting example predicted weather delay vs. parcel activity date and/or time, in accordance with an embodiment.

FIG. 25 is a schematic block diagram of an example computing device, in accordance with an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

As mentioned, integrated circuit devices, such as processors, for example, may be found in a wide range of electronic device types. For example, one or more processors may be used in various types of computing devices, such as, for example, cellular telephones, desktop computing devices, tablet devices, laptop and/or notebook computing devices, digital cameras, server computing devices, personal digital assistants, wearable devices, etc. Such computing devices may include integrated circuit devices, such as processors, to process signals and/or states representative of a diverse of content types for a wide variety of purposes.

For example, in some circumstances, computing devices may implement techniques to manage shipping, transportation, and/or delivery, for example, of parcels, for example. As utilized herein, “parcel” and/or the like refers to one or more items, products, merchandise, etc., that may be boxed, enveloped, wrapped, etc., for transport, such as via a courier service (e.g., Fed Ex, United Parcel Service, etc.). For example, a parcel may be transported from an origination location to a destination location. Also, for example, a parcel may, during transportation, pass through and/or stop (e.g., temporary storage) at one or more intermediate locations. Various markets, industries, business entities, organizations, and/or individuals, for example, may depend on parcels to be delivered to particular locations on and/or by particular times and/or dates. Such markets, industries, business entities, organizations, and/or individuals, for example, may benefit from an ability to predict distress of a shipment, such as may occur due to particular weather conditions, for example. Herein, “entity” and/or “user” and/or the like may be utilized interchangeably and/or may refer to any of a wide range of business entities, associations, organizations, and/or individuals, for example.

In some circumstances, pharmacies, including, for example, specialty pharmacies (e.g., Walgreen, Prime Therapeutics, Aetna, etc.), may benefit from an ability to predict distress of a shipment. For example, a particular pharmacy may wish to ship an item, such as a particular pharmaceutical, for example, to a particular location. Due at least in part to particular characteristics of a particular pharmaceutical to be shipped (e.g., perishable, expensive, etc.), it may be beneficial for a pharmacy, for example, to understand a probability, for example, of an item being successfully delivered by a particular date and/or time. In this manner, a pharmacy may avoid initiating a shipment if conditions are such that an item may have a reduced probability of arriving at an intended destination before perishing and/or degrading, for example.

As mentioned, a computing device may process various signals and/or signal samples, for example, to determine a probability of a particular parcel arriving at a particular destination and/or intermediate location by a particular time and/or date, for example. Such determinations, for example, may take into account relatively large amounts of digital content (e.g., signals and/or signal samples), such as content representative of current weather conditions, content representative of forecasted weather conditions, content representative of historical weather conditions, content representative of various characteristics of a particular shipping infrastructure, and/or content representative of historical parcel shipping events, for example. Digital content representative of natural disasters and/or other acts of God (e.g., earthquakes, fire, mudslides, floods, etc.) may also be taken into account in determining a probability of a particular parcel arriving at a particular destination and/or intermediate location by a particular time and/or date, for example.

In an embodiment, machine learning techniques, such as neural network models and/or other machine-based decision-making processes and/or algorithms, for example, may be implemented at least in part to process content representative of current weather conditions, forecasted weather conditions, historical weather conditions, various characteristics of a particular shipping infrastructure, and/or historical parcel shipping events, for example, to determine a probability of a particular parcel arriving at a particular destination and/or intermediate location by a particular time and/or date, for example. Embodiments may also include determining a particular time and/or date by which a particular parcel may arrive at a particular destination and/or intermediate location, for example.

In an embodiment, a computing device may generate a user-perceivable output, via a display device, for example, based at least in part on a determination of a probability of a particular parcel arriving at a particular destination and/or intermediate location by a particular time and/or date, for example. Provided with such a display, for example, particular entities (e.g., specialty pharmacies) and/or individuals may proactively plan to avoid shipping into distress. Also, embodiments may allow for identification of potential distress to parcels that have already been shipped which may allow for faster resolution, for example.

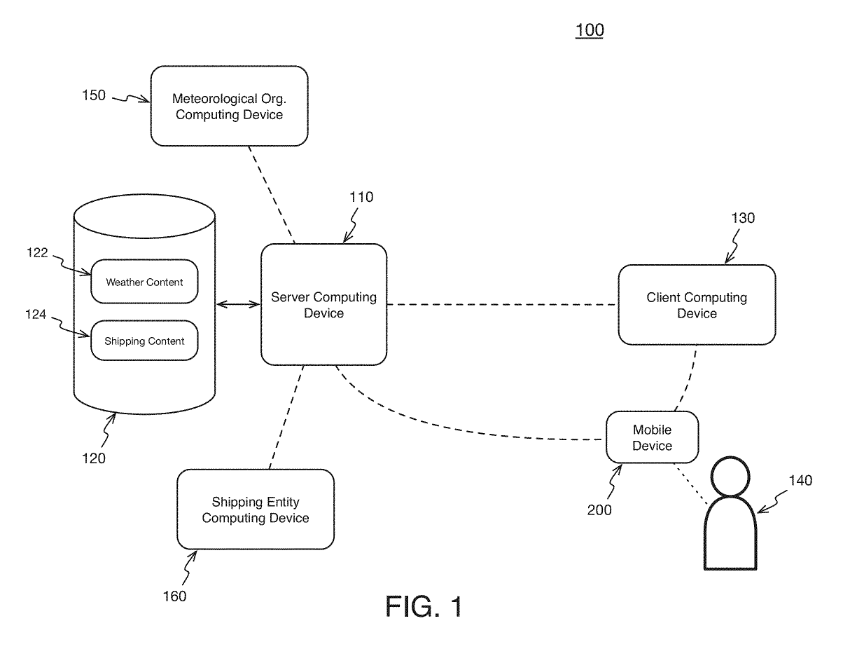

FIG. 1 is an illustration depicting an embodiment 100 of an example system for parcel transportation management. As utilized herein, “parcel transportation management” in this context refers to management of any aspect related to moving a parcel from one location to another location. In particular implementations, transport of a parcel may be accomplished via a commercial shipping entity, such as, for example, FedEx®, United Parcel Service (UPS®), United States Postal Service (USPS®), etc. In an embodiment, a system for parcel transportation management, such as example system 100, may include a server computing device, such as server computing device 110. A system, such as system 100, may further include a client computing device, such as client computing device 130, and/or a mobile computing device, such as mobile device 300. However, claimed subject matter is not limited in scope to any particular devices and/or any particular configuration of devices.

In an embodiment, a computing device, such as server computing device 110, for example, may access a database, such as database 120. In a particular implementation, a database, such as database 120, may comprise one or more memory devices configured to store signals and/or signal samples representative of various types of digital content. In an particular implementation, digital content to be stored in a database, such as database 120, may include, for example, weather content, such as weather content 122, and/or shipping content, such as shipping content 124.

In an embodiment, weather content, such as weather content 122, may include, for example, historical weather records, parameters indicative of current weather conditions, or parameters representative of forecasted weather conditions, or any combination thereof. Further, in an embodiment, shipping content, such as shipping content 124, may include, for example, historical parcel shipping activity records, parameters representative of current parcel shipping activity, or parameters indicative of particular characteristics of a particular parcel shipping infrastructure, or any combination thereof. However, claimed subject matter is not limited in scope in these respects. As utilized herein, “record” refers to a collection of digital content (e.g., electronic file, electronic document, etc.). In an embodiment, a record may include one or more parameters. For example, in an particular implementation, a historical weather record, for example, may include content representative of one or more weather observations and/or measurements, for example.

In a particular implementation, a computing device, such as server computing device 110, may obtain weather content, such as weather content 122, from one or more weather stations and/or from one or more meteorological organizations, for example. In a particular implementation, historical weather records, parameters indicative of current weather conditions, and/or parameters representative of forecasted weather conditions, for example, may be obtained from the National Oceanic and Atmospheric Administration (NOAA), for example. In an embodiment, one or more signal packets representative of weather content, such as weather content 122, for example, may be communicated between at least one computing device, such as meteorological computing device 150 located at and/or associated with one or more meteorological organizations, for example, and a server computing device, such as server computing device 110. In an embodiment, communication of signal packets may include wired and/or wireless communication between nodes of a network, such as the Internet, wherein a node may comprise one or more network devices and/or one or more computing devices, for example. Additional non-limiting examples of communication networks and/or signal packet communication technologies are provided below.

In an embodiment, content obtained from a meteorological organization, such as NOAA, for example, may include Quality-Controlled Local Climatological Content (QCLCD) which may include at least hourly, for example, parameters indicative of current and/or historical weather observations and/or measurements from a number (e.g., thousands) of weather stations across the United States, for example, although claimed subject matter is not limited in scope to any particular geographical area. Also, in an embodiment, parameters indicative of weather observations and/or measurements may be obtained, such as by sever computing device 110, for example, without aid and/or intervention of a meteorological organization. For example, in a particular implementation, parameters indicative of current and/or historical weather observations and/or measurements may be obtained directly from one or more weather stations via signal packet communication over a network. In an embodiment, QCLCD content may date back, in at least some circumstances, several years. Additionally, QCLCD content may include parameters indicative of geographical locations of particular weather stations. In a particular implementation, at least some individual records comprising particular weather observations and/or measurements may include parameters indicative of particular weather stations to have supplied particular observations and/or measurements.

As utilized herein, “current” in the context of weather content, such as weather content 122, and/or shipping content, such as shipping content 124, for example, refers to substantially and/or approximately current. For example, in a particular implementation, “current” parameters indicative of weather observations and/or measurements may include parameters indicative of particular observations and/or measurements taken within an hour of a present time. Further, “current” parameters indicative of parcel shipping events may include parameters indicative of shipping events to have occurred within an hour of a present time, for example.

In an embodiment, a computing device, such as server computing device 110, may obtain shipping content, such as shipping content 124, from one or more shipping entities. For example, in a particular implementation, historical parcel activity records, parameters indicative of current parcel shipping event records, and/or parameters indicative of one or more characteristics of a particular shipping infrastructure may be obtained from one or more particular shipping entities, such as, for example, FedEx, UPS, USPS, etc. For example, one or more signal packets representative of shipping content, such as shipping content 124, may be communicated between at least one computing device, such as shipping entity computing device 160 located at and/or associated with one or more shipping entities, and a server computing device, such as server computing device 110, in a particular implementation.

In an embodiment, shipping content, such as shipping content 124, may include relatively large amounts of content representative of historical parcel shipping activity accumulated over a relatively long period of time, such as a number of years (e.g. fifteen years). In an embodiment, historical parcel shipping activity records may comprise one or more parameters indicative various aspects of particular parcel shipments from a number of origination locations to a number of destination locations over a period of time. In a particular implementation, historical shipping activity records may include parameters representative of particular parcel shipments occurring over an approximately six-month period of time, although claimed subject matter is not limited in scope in this respect. In a particular implementation, individual historical parcel shipping activity records may include parameters indicative of an approximate geographical location (e.g., city and/or state) to indicate an approximate geographic location of a particular parcel activity, for example. Examples of parcel shipping activities and/or events may include, but are not limited to, date and/or time of arrival at a particular location, date and/or time of departure from a particular location, and/or date and/or time of delivery at a particular destination location. Further, in a particular implementation, historical parcel shipping activity records may include one or more parameters indicative of whether or not a parcel was delivered by a specified time and/or date. Also, for example, historical parcel shipping activity records may include a parameter to indicate whether a particular delivery was delayed beyond a specified time (e.g., late delivery) due at least in part to adverse weather conditions. Additionally, in an embodiment, individual historical and/or current parcel shipping activity records may include an identifier, such as a tracking parameter, for example. In an embodiment, a parcel tracking parameter (e.g., tracking number) may be utilized to link and/or otherwise associate particular parcels with particular parcel shipping activities. In an embodiment, a parcel tracking parameter may comprise a value to uniquely identify a particular parcel among various commercial shipping entities. Further, in a particular implementation, shipping content, such as shipping content 124, may comprise a table of postal codes for the United States, for example, which may map individual ZIP codes to a particular area centered about a particular latitude/longitude pair, for example.

In an embodiment, a computing device, such as server computing device 110, for example, may implement one or more machine learning techniques, for example, to process weather content, such as weather content 122, and/or shipping content, such as shipping content 124, for example, to determine effects of particular weather conditions on probabilities of on-time delivery of given parcels. In an embodiment, a user, such as user 140, for example, may initiate an operation to determine a probability of a particular parcel arriving at a particular destination and/or intermediate location by a particular time and/or date. In an embodiment, a user, such as user 140, may initiate such an operation via interaction with a user interface of a computing device, such as mobile device 300. Further, in an embodiment, on or more signal packets representative of a user initiation of an operation to determine a probability of a particular parcel arriving at a particular destination and/or intermediate location by a particular time and/or date may be communicated between a computing device, such a mobile device 300, and another computing device, such as server computing device 110 and/or a client computing device, such as client computing device 130, for example. In an embodiment, a client computing device, such as client computing device 130, may be physically located at and/or may be controlled by a particular entity, such as a particular pharmacy, for example. Further, in an embodiment, a computing device, such as client computing device 130, may obtain, such as from mobile device 300, for example, a signal packet indicative of a user initiation of an operation to determine a probability of a particular parcel arriving at a particular destination and/or intermediate location by a particular time and/or date and/or may initiate communication of a signal packet indicative of such a user initiation between a computing device, such as client computing device 130, and another computing device, such as server computing device 110, for example.

As mentioned, a computing device, such as server computing device 110, for example, may implement one or more machine learning techniques, for example, to process weather content, such as weather content 122, and/or shipping content, such as shipping content 124, for example, to determine a probability of a particular parcel arriving at a particular destination and/or intermediate location by a particular time and/or date. In an embodiment, a computing device, such as server computing device 110, may generate one or more signal packets representative of a content for display representative of a determination of a probability of a particular parcel arriving at a particular destination and/or intermediate location by a particular time and/or date. In a particular implementation, signal packets representative of content for display may be communicated between a computing device, such as server computing device 110, and another computing device, such as client computing device 130 and/or mobile device 300. In an embodiment, signal packets representative of content for display, such as content for display representative of a determination of a probability of a particular parcel arriving at a particular destination and/or intermediate location by a particular time and/or date, may be rendered by a computing device, such as client computing device 130 and/or mobile device 300, for display to a user, such as user 140.

Although embodiments herein describe a computing device, such as server computing device 110, implementing machine learning techniques to process weather content and/or shipping content to determine effects of particular weather conditions on transportation of particular parcels, claimed subject matter is not limited in scope to such machine learning techniques being implemented by a server computing device, such as server computing device 110, for example. In particular implementations, a client computing device, such as client computing device 130, and/or a mobile device, such as mobile device 300, for example, may perform operations to determine effects of particular weather conditions on transportation of particular parcels. For example, machine learning techniques may be implemented by client computing device 130 and/or mobile device 300 to determine a probability of a particular parcel arriving at a particular destination and/or intermediate location by a particular time and/or date. In an embodiment, a computing device, such as client computing device 130 and/or mobile device 300, may obtain weather content, such as weather content 122, and/or shipping content, such as shipping content 124, from a database, such as database 120. In an embodiment, weather content, such as weather content 122, and/or shipping content, such as shipping content 124, may be obtained via signal packet communication between a server computing device, such as server computing device 110, and another computing device, such as client computing device 130 and/or mobile device 200, for example.

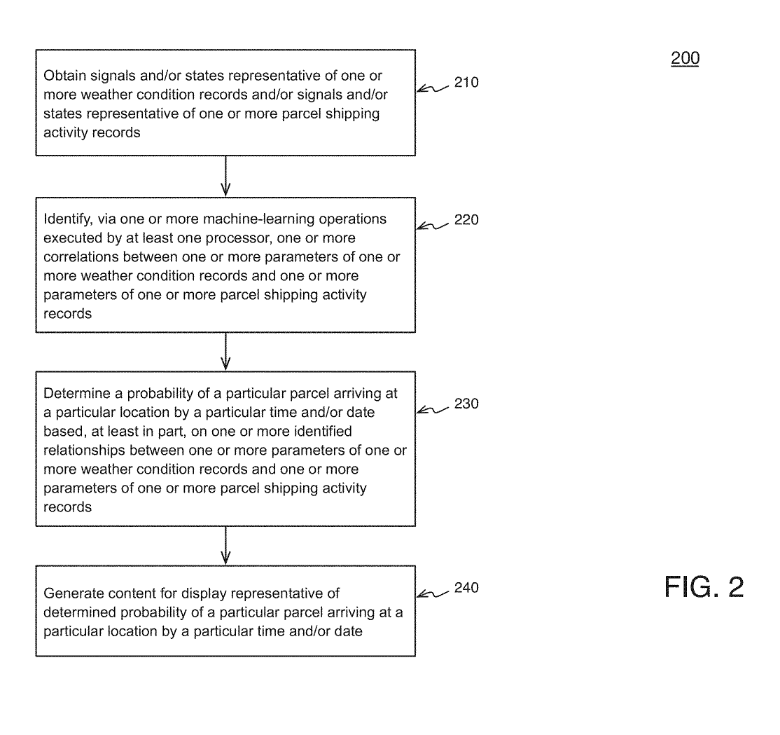

FIG. 2 is an illustration depicting an embodiment 200 of an example process for determining a probability of a particular parcel arriving at a particular location by a particular time and/or date. Embodiments in accordance with claimed subject matter may include all of blocks 210-240, fewer than blocks 210-140, and/or greater than blocks 210-240. Further, the order of blocks 210-240 is merely an example order, and claimed subject matter is not limited in scope in these respects. As depicted at block 210, signals and/or states representative of one or more weather condition records may be obtained. For example, weather condition records may be obtained by a computing device, such as mobile device 300, from a database, such as database 120, via a networked computing device, such as server computing device 110. Also, as depicted at block 210, signals and/or states representative of parcel shipping activity records may be obtain in a similar fashion, for example.

As indicated at block 220, one or more correlations between one or more parameters of weather condition records and one or more parameters of parcel shipping activity records may be identified at least in part via machine-learning operations. For example, a computing device, such as mobile device 300, for example, may execute program code to implement one or more machine-learning operations to identify one or more correlations between one or more parameters of weather condition records and one or more parameters of parcel shipping activity records, in an embodiment. Additionally, as depicted at block 230, a probability of a particular parcel arriving at a particular location by a particular time and/or date may be determined based, at least in part, on one or more identified correlations between one or more parameters of weather condition records and one or more parameters of parcel shipping activity records. In an embodiment, a probability may be determined, at least in part, via execution of program code implementing machine-learning operations, for example. Further, in an embodiment, content for display representative of a determined probability of a particular parcel arriving at a particular location by a particular time and/or date may be generated. For example, signals and/or states representative of content for display may be generated by a computing device, such as mobile device 300, for example.

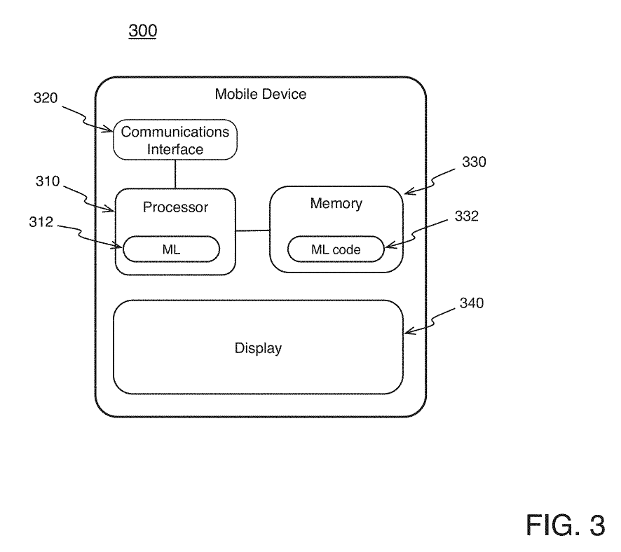

FIG. 3 is an illustration depicting a block diagram of an embodiment 300 of a mobile computing device. In an embodiment, a mobile device, such as mobile device 300, may comprise one or more processors, such as processor 310, and/or may comprise one or more communications interfaces, such as communications interface 320. In an embodiment, one or more communications interfaces, such as communications interface 320, may enable wireless communications between a mobile device, such as mobile device 300, and one or more other computing devices, such as server computing device 110 and/or client computing device 130, for example. In an embodiment, wireless communications may occur substantially in accordance any of a wide range of communication protocols, such as those mentioned herein, for example.

In an embodiment, a mobile device, such as mobile device 300, may include a memory, such as memory 330. In an embodiment, memory 330, for example may comprise a non-volatile memory, for example. Further, in an embodiment, a memory, such as memory 330, for example, may have stored therein executable instructions, such as for one or more operating systems, communications protocols, and/or applications, for example. A memory, such as memory 330, may further store particular instructions, such as machine-learning code 312, for example, executable by a processor, such as processor 310, to determine a probability of a particular parcel arriving at a particular destination and/or intermediate location by a particular time and/or date, for example. Further, in a particular implementation, a mobile device, such as mobile device 300, for example, may comprise a display, such as display 340, for example, to render content for display representative of a determination of a probability of a particular parcel arriving at a particular destination and/or intermediate location by a particular time and/or date, for example. Also, although processor 310 is described as executing instructions, such as machine learning code 312, for example, other embodiments may include dedicated and/or specialized circuitry for processing weather content, such as weather content 122, and/or shipping content, such as shipping content 124, for example, to implement machine-learning operations, such as neural network operations, for example, to determine a probability of a particular parcel arriving at a particular destination and/or intermediate location by a particular time and/or date, for example.

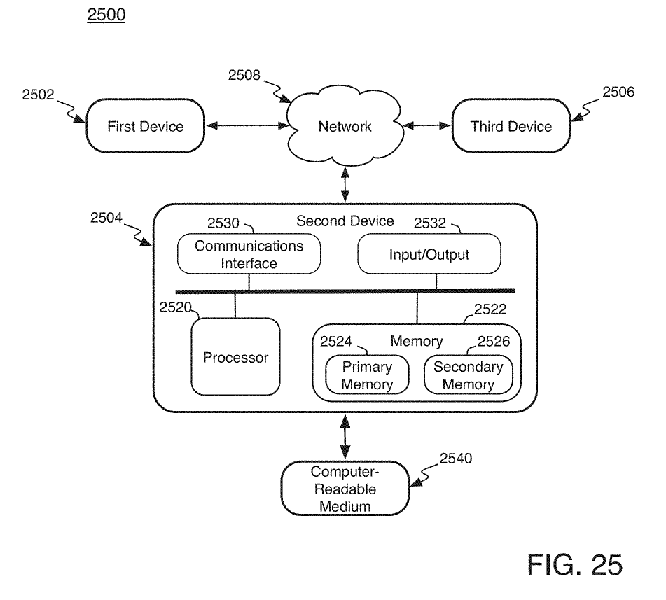

Although FIG. 3 depicts an embodiment of a mobile device, such as mobile device 300, other embodiments may include other types of computing devices. Example types of computing devices may include, for example, any of a wide range of digital electronic device types, including, but not limited to, server, desktop and/or notebook computers, high-definition televisions, digital video players and/or recorders, game consoles, satellite television receivers, cellular telephones, tablet devices, wearable devices, personal digital assistants, mobile audio and/or video playback and/or recording devices, or any combination of the foregoing. Additional embodiments of computing devices that may implement operations, such as machine-learning operations, to determine probabilities of particular parcels arriving at particular destinations and/or intermediate locations by particular times and/or dates, for example, are described below in connection with FIG. 25.

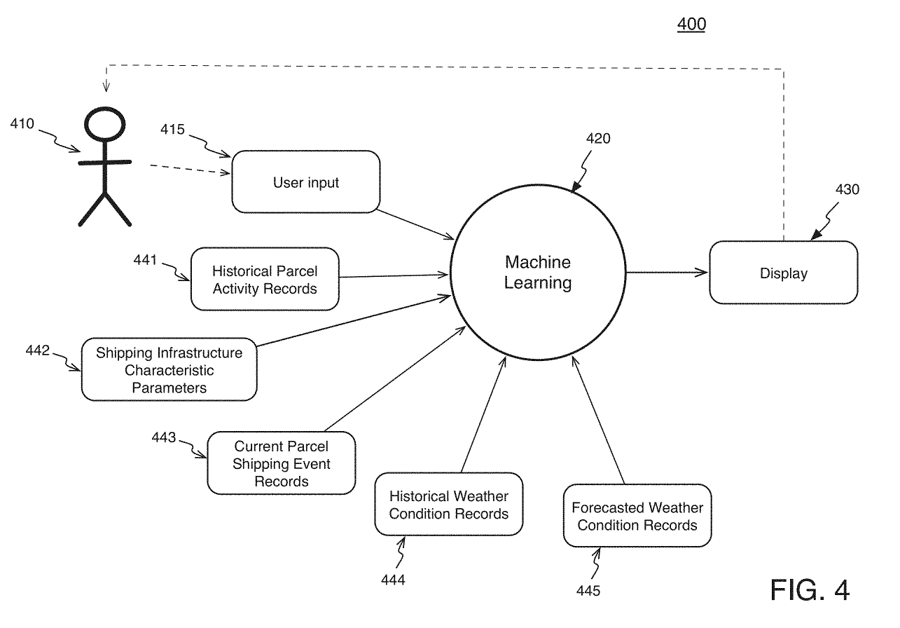

FIG. 4 is an illustration depicting an embodiment 400 of an example process, including example machine learning techniques, to generate content representative of a user-perceivable display, such as a display 430, based at least in part on a determination of a probability of a particular parcel arriving at a particular destination and/or intermediate location by a particular time and/or date, for example. In an embodiment, machine learning operations, such as machine-learning operations 420, including, for example, neural network implementations and/or other machine-based decision-making processes and/or algorithms, for example, may be executed by a computing device, such as mobile device 300, to determine a probability of a particular parcel arriving at a particular destination and/or intermediate location by a particular time and/or date, for example.

In an embodiment, machine-learning operations, such as machine-learning operations 420, may process signals and/or signal samples representative of historical weather content, such as historic weather condition records 444, historical shipping related content, such as historical parcel shipping activity records 441, and/or shipping infrastructure content, such as shipping infrastructure characteristic parameters 442, to determine, for example, effects of particular historical weather conditions on transportation of particular parcels. In a particular implementation, adverse effects on transportation of particular parcels due to particular weather conditions observed and/or measured at particular geographic locations and/or regions, for example, may be determined.

For example, in an embodiment, machine-learning operations, such as operations 420, may include an implementation of a neural network model, for example. In an embodiment, a neural network may comprise a number of parameters that may be trained based at least in part on one or more determinations of adverse effects on transportation of particular parcels due to particular weather conditions observed and/or measured at particular geographic locations and/or regions, for example. In an embodiment, historical weather content, such as historic weather condition records 444, and/or historical parcel shipping activity content, such as historical parcel shipping activity records 441, may at least substantially overlap with respect to a specified period of time. For example, particular weather events may be matched to particular shipping events based, at least in part, on parameters indicative of time, date, and/or location for historical weather condition records 444 and/or historical parcel shipping activity records 441.

Further, in an embodiment, machine learning operations, such as machine-learning operations 420, may employ a trained neural network model to process content representative of current shipping events, such as current parcel shipping event records 443, parameters representative of characteristics of a particular shipping infrastructure (e.g., modes of transportation, routes, personnel, rates, physical locations of warehouses, storefronts, etc.), such as shipping infrastructure characteristic parameters 442, and/or forecasted weather content, such as forecasted weather condition records 445, to determine a probability of a particular parcel arriving at a particular destination and/or intermediate location by a particular time and/or date, for example.

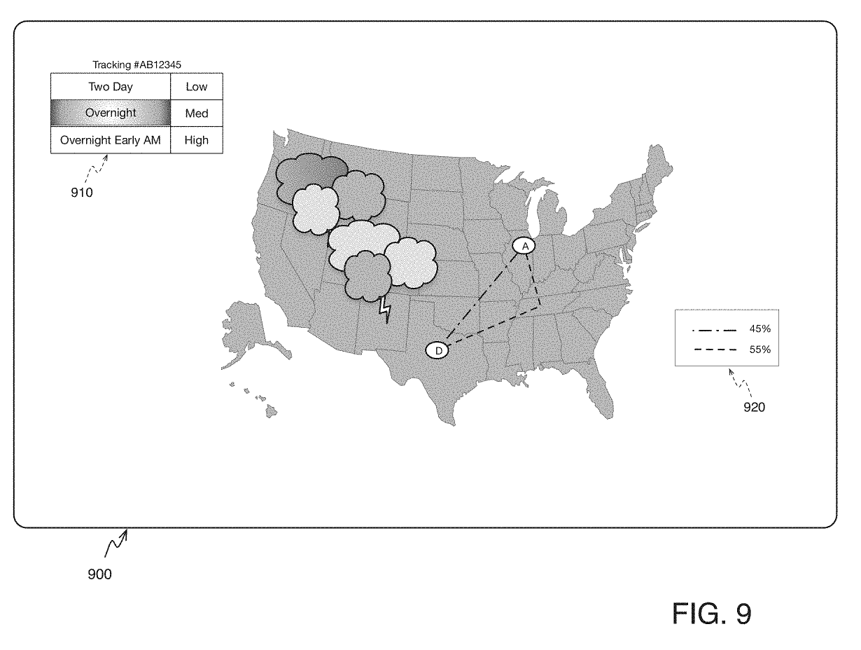

As further indicated at FIG. 4, a user, such as user 410, may provide user input, such as user input 415, that may, at least in part, guide operation of machine-learning operations, such as machine-learning operations 420. For example, a user, such as user 410, may provide, such as via interaction with a user interface of a computing device, such as mobile device 300, an identification of a particular parcel. At least in part in response to an identification of a particular parcel, machine-learning operations, such as machine-learning operations 420, may generate a content for display, such as display 430, comprising user-perceivable content indicating a determined probability of an identified parcel arriving at a particular destination and/or intermediate location by a particular time and/or date, in an embodiment. Example rendered content for display is discussed below in connection with FIG. 9.

In some circumstances, determining a probability of a given future shipment based on a relatively large number of variables may pose challenges. For example, weather prediction technology may be generally considered to be increasingly accurate. However, correlation between weather and parcel delivery performance may be challenging because, for example, a two inch snowfall may have almost no negative impact in one geographic region yet similar weather conditions in a different region may have a relatively highly negative impact on parcel delivery performance. As utilized herein, a “successful delivery” refers to delivery of a particular parcel to a specified destination location by a specified time and/or date. Similarly, an “unsuccessful delivery” refers to a failure to deliver a particular parcel to a particular destination location by a specified time and/or date.

As indicated above, particular shipping infrastructures for particular shipping entities may be characterized at least in part by one or more parameters, such as shipping infrastructure characteristic parameters 442. In an embodiment, a computing device, such as server computing device 110, client computing device 130, and/or mobile device 300, for example, may determine a time and/or date by which a given parcel may arrive at particular intermediate locations along a specified route and/or may further determine a probability, for example, of a negative impact on parcel transportation due to weather and/or natural disasters, for example, at particular intermediate locations along a specified route. In an embodiment, determining probabilities of negative impact on parcel transportation due to weather and/or natural disasters, for example, at particular intermediate locations along a specified route may yield improved accuracy as compared with implementations merely considering weather alerts, for example, tied to origin and/or destination locations.

Although specialty pharmacies are mentioned herein as a type of entity that may benefit from example implementations disclosed herein, claimed subject matter is not limited in scope in this respect. Rather, example embodiments such as disclosed herein may be advantageously employed in a wide range of industries and/or entities.

As mentioned, in some circumstances, an impact of weather on parcel shipments may be of significant concern to various entities, such as specialty pharmacies, for example. Embodiments described herein may process significant amounts of content, such as weather content 122 and/or shipping content 124, in developing and/or training machine-learning models, for example, having sufficient predictive capability for a particular entity's business purposes. In an embodiment, a relatively large set of digital content representative of several million parcel shipments, for example, may be obtained. For example, a computing device, such as server computing device 110, may obtain digital content representative of historical parcel shipping records, such as shipping content 124, from one or more computing devices, such as shipping entity computing device 160. In an embodiment, individual records for respective parcel shipments may include approximately five to ten parcel shipping activity parameters, although claimed subject matter is not limited in scope in this respect. For example, individual records for particular parcel shipments may include parameters representative of a time of departure from an origin location, times of arrival at one or more intermediate locations, a time of delivery at a destination location, and/or a tracking identifier, for example. Additionally, in an embodiment, a relatively extensive set of climatological content, such as weather content 124, may be obtained from one or more meteorological organizations, such as NOAA. For example, a computing device, such as server computing device 110, may obtain digital content representative of historical weather condition records, such as weather content 122, from one or more computing devices, such as meteorological organization computing device 150.

In an embodiment, a computing device, such as server computing device 110, for example, may process weather content, such as weather content 122, and/or shipping content, such as shipping content 124, at least in part by performing one or more particular operations. In a particular implementation, code written in a Structured Query Language (SQL), such as SQL:2016 released December 2016, for example, may be executed by a computing device, such as server computing device 110, to import and/or process digital content. Example implementations of code, such as “Data_Import.sql” and/or “Capstone®,” are listed in the Computer Program Listing Appendix, although claimed subject matter is not limited in scope to particular example code implementations provided herein. Also, although example embodiments described herein may be implemented via execution of software code, other embodiments may be implemented in hardware, firmware, or software, or any combination thereof. Further, claimed subject matter is not limited in scope to any particular programming language.

Example processes that may be applied to weather content, such as weather content 122, for example, may include conversion of content gathered from geological organizations and/or from weather stations, such as QCLCD weather content, from textual parameters to numeric parameters, for example. Additionally, for example, particular weather content determined to pertain to weather stations located outside of a specified geographical region and/or determined to include at least a specified amount of null parameters may be removed from a particular content set, such as weather content 122, for example.

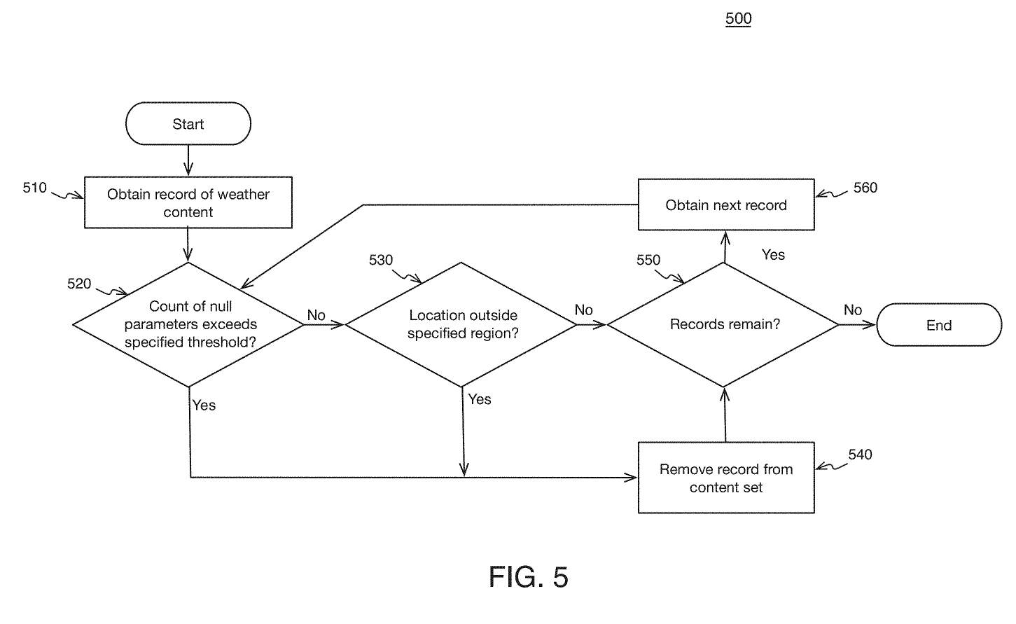

FIG. 5, for example, depicts an embodiment 500 of an example process for removing particular weather records from a weather content set. Embodiments in accordance with claimed subject matter may include all of blocks 510-560, fewer than blocks 510-560, or greater than blocks 510-560. Further, the order of blocks 510-560 is merely an example order, and claimed subject matter is not limited in scope in this respect. As depicted at block 510, a record may be obtained from a particular weather content set. For example, a computing device, such as server computing device 110, may obtain a particular record from weather content 122 stored in database 120. In an embodiment, individual records may include a plurality of particular parameters, such as, for example, parameters indicative of location, time and/or date, and/or one or more meteorological measurements and/or observations. Example records and/or parameters for weather content, such as weather content 124, is provide below in connection with Table 1.

As depicted at block 520, a determination may be made as to whether an amount of parameters within a current record exceeds a specified threshold amount. In an embodiment, a computing device, such as server computing device 110, may analyze parameters of a particular record to determine a count of null records, for example. Additionally, as depicted at block 530, a determination may further be made, such as via a computing device (e.g., server computing device 110) as to whether a particular parameter of a particular record indicates a particular location outside of a specified region. In a particular implementation, if a particular record includes an amount of null parameters that exceeds a specified threshold and/or if a particular parameter of a particular record indicates a particular location outside of a specified region, a particular record may be removed from a particular content set, such as weather content 122, as indicated at block 540. Further, as indicated at block 550, a next record may be obtained, as depicted at block 560, responsive to a determination that additional records of a particular content set remain to be processed. In an embodiment, a computing device, such as server computing device 110, may store an updated content set, such as weather content 122, in a database, such as database 120, for example.

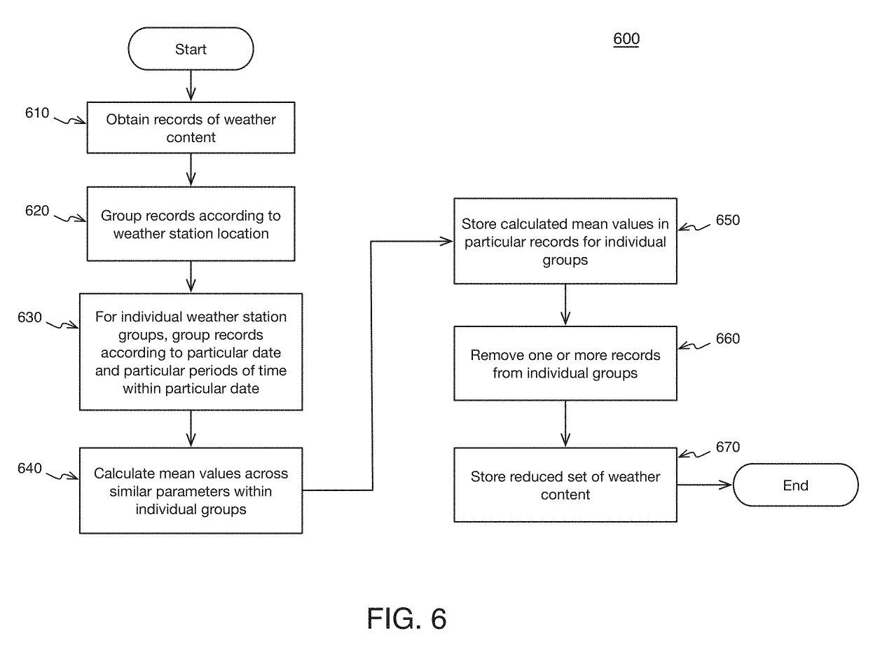

FIG. 6 depicts an illustration of an embodiment 600 of an example process for reducing an amount of records within a set of weather content, such as weather content 122, for example. Embodiments in accordance with claimed subject matter may include all of blocks 610-670, fewer than blocks 610-670, or greater than blocks 610-670. Further, the order of blocks 610-670 is merely an example order, and claimed subject matter is not limited in scope in this respect. In an embodiment, climatological content, such as weather content 122, may be grouped according to particular periods of time, such as according to a nearest hour, for particular dates and/or may be grouped according to particular weather station and/or weather station location to reduce a count of records within a particular content set. For example, as depicted at block 610, records of a particular content set, such as weather content 122, may be obtained. In an embodiment, a computing device, such as server computing device 110, may obtain records from weather content 122 stored in database 120, for example. Further, as depicted at block 620, records may be grouped according to particular weather stations and/or weather station locations, as identified, for example, by one or more particular parameters of individual records. In an embodiment, records may be grouped such that records pertaining to weather stations located within particular specified geographical regions, for example. Additionally, records of individual groups partitioned according to particular geographical regions and/or according to particular weather stations and/or particular weather station locations may be further grouped according to particular times of day, for example, and/or according to particular dates, as indicated, for example, at block 630.

In an embodiment, mean values, for example, may be calculated across similar parameters for records of individual groups, for example, as depicted at block 640. Calculated mean values may be stored, for example, in particular records for particular groups, for example, as depicted at block 650. In an embodiment, multiple records pertaining to particular groups may be replaced by a single record, for example, comprising parameters determined by calculating mean values, for example, across similar parameters within particular groups. As depicted at block 660, for example, particular records from particular groups may be removed from a content set. In this manner, for example, a total count of records within a particular content set, such as weather content 122, may be reduced, in an embodiment. In a particular implementation, a reduced set of content, such as weather content, may be stored, such as in database 122, for example. In an embodiment, an hourly resolution (e.g., records grouped according to period of time specified as one hour in duration) may be specified, although claimed subject matter is not limited in scope in this respect. In an embodiment, a reduction in an amount of content in a weather content set, such as weather content 122, may result in more efficient processing. In an embodiment, trade-offs between processing efficiency and accuracy may be considered.

In a particular implementation, some records may be reconstructed and/or interpolated. For example, particular parameters missing from particular records may be estimated based, at least in part, on parameters from other records. For example, for a situation in which a wind speed measurement parameter may be missing from a record pertaining to a particular weather station for a particular period of time and/or date, for example, an average wind speed for a particular date may be utilized to replace a missing wind speed measurement parameter. For another example, for a situation in which a relative humidity parameter is missing for a particular record, for example, a relative humidity value may be calculated based at least in part on a relation involving dry and/or wet bulb temperature readings, in an embodiment.

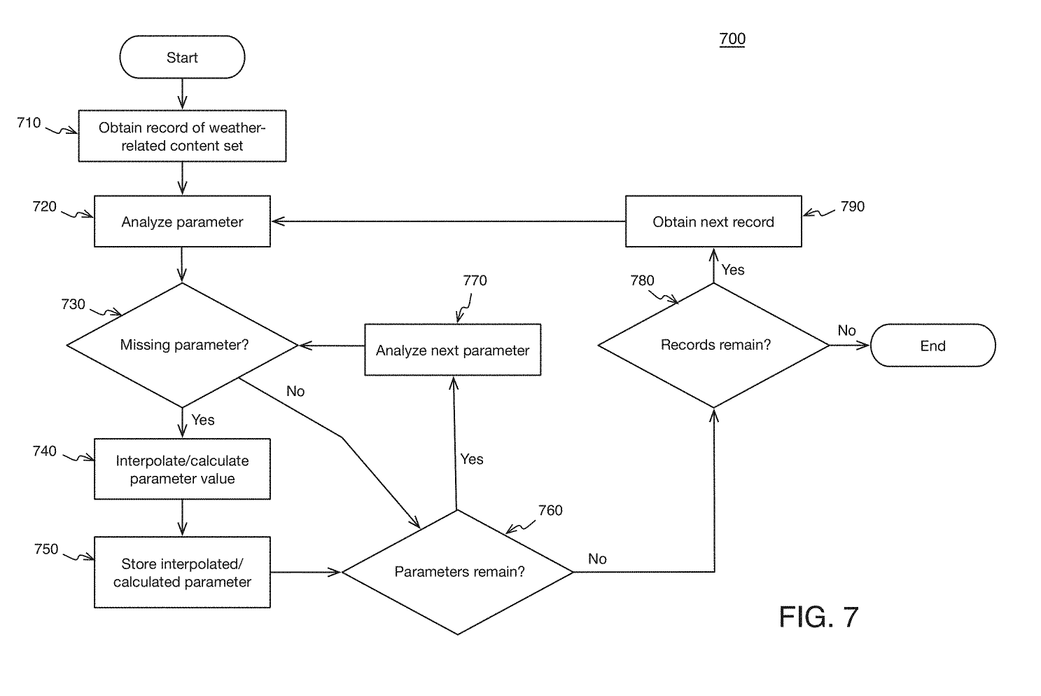

FIG. 7 depicts an illustration of an embodiment 700 of an example process for replacing missing parameters within particular records of a set of weather content, such as weather content 122, for example. Embodiments in accordance with claimed subject matter may include all of blocks 710-790, fewer than blocks 710-790, or greater than blocks 710-790. Further, the order of blocks 710-790 is merely an example order, and claimed subject matter is not limited in scope in this respect. In a particular implementation, a computing device, such as server computing device 110, may obtain records from weather content 122 stored in database 120, for example, as depicted at block 710. Also, in an embodiment, a computing device, such as server computing device 110, may analyze a particular parameter of a particular record of weather content, as depicted at block 720. As depicted at block 730, at least in part in response to a determination of a missing parameter, a computing device, such as server computing device 110, may interpolate and/or otherwise calculate a parameter value based at least in part on one or more parameter values from one or more records. Further, an interpolated and/or otherwise calculated parameter value may be stored in a particular record of weather content, as indicated at block 750. For example, a computing device, such as server computing device 110, may store an interpolated and/or otherwise calculated value to weather content, such as weather content 122, within a database, such as database 120.

Further, in an embodiment, at least in part in response to additional parameters remaining to be processed, a next parameter may be analyzed, as indicated, for example, at blocks 760 and/or 770. As also indicated at block 760 and/or block 780, a determination with respect to additional records to be processed may be made responsive to a determination that no further parameters remain to be processed. Further, at least in part in response to a determination that further records remain to be processed for a particular weather content set, a next record may be obtained, as indicated at block 790. In an embodiment, a computing device, such as server computing device 110, may seek missing parameters across a plurality of records within a set of weather content, such as weather content 122, for example, and/or may determine replacement parameter values for detected missing parameters.

In an embodiment, various operations may be performed via a computing device, such as server computing device 110, for example, on shipping content, such as shipping content 124. For example, at least in part responsive to obtaining historical parcel activity content, such as historical parcel activity records 441, from one or more commercial courier entities, for example, one or more proprietary and/or irrelevant parameters and/or records may be removed from a set of shipping related content, such as shipping related content 124. In an embodiment, historical parcel activity content, such as historical parcel activity records 441, may include “rounded date time” parameters comprising values indicative of a particular time of day and/or date (e.g., nearest hour for a particular date) for individual parcel activities and/or events. In an embodiment, time and/or date designations, such as “rounded date time” parameters, may be specified to match weather content, such as weather content 122, grouped in accordance with example grouping operations described above, for example.

In an embodiment, parcel activity content, such as historical parcel activity records 441, may include, for example, a parameter indicative of a postal code (e.g., ZIP code) that may be assigned, such as by a computing device (e.g., server computing device 110) according to particular city and/or state pairs, for example. Content, such as historical parcel activity records 441, may be edited, in an embodiment, to enforce uniformity of city and/or state names, for example, across historical parcel activity record parameters, for example. In an embodiment, one or more parameters of a postal code table, for example, may specify a name of a city as “SAINT LOUIS,” for example, wherein a particular parameter of a historical parcel activity record, such as a particular historical parcel activity record 441, may specify a name of a city as “ST. LOUIS,” resulting, for example, in a mismatch. In an embodiment, a computing device, such as server computing device 110, may analyze city and/or state names and/or may analyze postal code parameter values of various records of historical parcel activity content, such as historical parcel activity records 441, and/or may perform one or more substitutions of particular parameter values with particular specified values to ensure substantial and/or relative uniformity across similar parameters of various records. For example, a parameter value of “Saint” may be replaced with a specified value of “St.” Similarly, “MOUNT” may be replaced with “MT”, “FORT” with “FT.”, etc. In an embodiment, city and/or state names, for example, may be converted to all upper case, and/or white spaces and/or special characters may be eliminated, in an embodiment. In an embodiment, parameter values for which no substitution may be specified may be eliminated, for example.

In an embodiment, individual records of historical parcel activity content, such as historical parcel activity records 441, may include parameters indicative of a location associated with a particular shipping activity and/or event for a particular parcel and/or parcel shipment. In a particular implementation, a computing device, such as server computing device 110, may, via execution of machine-learning code, such as machine-learning operations 420, identify particular historical weather condition content, such as particular historical weather condition records 444 based, at least in part, on parameters indicative of particular locations and/or parameters representative of particular times and/or dates associated with particular parcel shipping activities and/or events. For example, with latitude and/or longitude parameters and/or with time and/or date parameters for a particular parcel activity, particular weather observation content, such as particular historical weather condition records 444, may be identified as being recorded nearest in time and/or location to a particular parcel activity. In an embodiment, matching of particular historical weather condition records with particular parcel activity records may be accomplished at least in part via a particular geo-spatial toolset, such as PostGIS (Spatial and Geographical Objects for PostgreSQL), release 2.4.2 dated Nov. 15, 2017, for example.

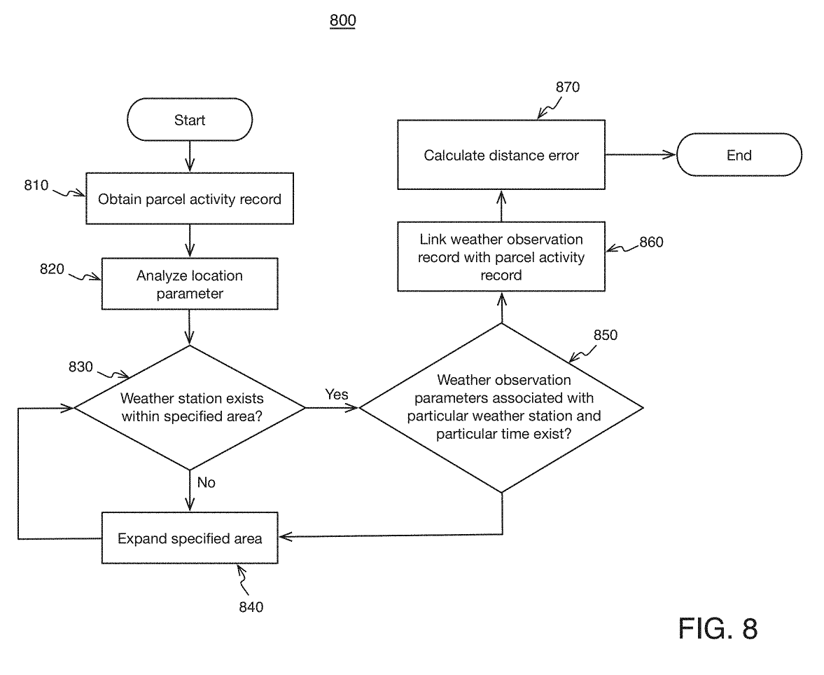

FIG. 8 depicts an illustration of an embodiment 800 of an example process for linking particular historical parcel activity content, such as particular historical parcel activity records 441, with particular historical weather condition content, such as particular historical weather condition records 444, for example. Embodiments in accordance with claimed subject matter may include all of blocks 810-870, fewer than blocks 810-870, or greater than blocks 810-870. Further, the order of blocks 810-870 is merely an example order, and claimed subject matter is not limited in scope in this respect. In a particular implementation, a computing device, such as server computing device 110, may obtain historical parcel activity content, such as historical parcel activity records 441, from shipping content 124 stored in database 120, for example, as depicted at block 810. Historical weather condition content, such as historical weather condition records 444, may also be obtained, for example, from weather content 122 stored in database 120, in an embodiment.

As depicted at block 820, a parameter indicative of a location associated with a particular historical parcel activity record may be analyzed. Based, at least in part, on a particular location specified by a particular parameter of a particular historical parcel activity record, for example, a particular geographical region may be specified. Further, as indicated at block 830, a determination may be made as to whether a specified geographical region includes one or more particular weather stations. In an embodiment, at least in part in response to no particular weather stations having been identified as being located within a specified geographical region, a specified geographical region may be expanded, as indicated, for example, at block 840. Further, as indicated again at block 830, a determination may be made as to whether any particular weather stations are located within a specified geographical region. In an embodiment, an iterative process may be performed, whereby a specified geographical region may be expanded upon each iteration until at least one weather station may be identified as being located within a specified region.

In a particular implementation, an iterative process may also include determining whether weather observation parameters associated with one or more particular weather stations determined to be located within a specified geographical region may be recorded for a time period and/or date associated with a particular historical parcel activity record, as indicated, for example, at block 850. In an embodiment, at least in part in response to no weather observation parameters associated with one or more particular weather stations determined to be located within a specified geographical region being recorded, a specified geographical area may be expanded as indicated at block 840. In this manner, a search for a nearest weather station having recorded weather observation parameters for a time period and/or date associated with a particular historical parcel activity record may continue until such a weather station may be identified, in an embodiment. At least in part in response to such an identification, one or more particular weather observation records may be linked with one or more particular historical parcel activity records, as indicated, for example, at block 860.

In some situations, multiple iterations may be employed to associate particular historical parcel activity records with particular historical weather observations, in an embodiment. As indicated at block 840, successive iterations may result in an expansion of a specified geographical area. In an embodiment, a “distance error” indicative of a distance between a location of a particular identified weather station and a geographical centroid, specified at least in part by a particular location parameter, for an individual historical parcel activity record may be calculated, as indicated at block 870. In another embodiment, an example process may include an iterative algorithm to include searches for a next closest weather station in both time and geographical space, for example.

FIG. 9 is an illustration depicting an embodiment 900 of an example display of a determined probability of a particular parcel arriving at a particular location by a particular time and/or date. Embodiment 900, for example, may depict an example display of a client portal, whereby a client, such as a specialty pharmacy, may view content related to parcel transportation and/or delivery, including, for example, parcel delivery predictions, in an embodiment. Various content may be displayed, including, but not limited to, predicted parcel route, weather forecast, parcel delivery options, predicted risk of parcel not being delivered by a given time, etc. Of course, embodiments are not limited in scope to the specific examples provided herein.

In an embodiment, a display, such as display 900, may include a map of a geographic region (e.g., continental United States of America, particular regions of U.S.A., etc.). A display, such as display 900, may also, for example, include a representation of particular weather conditions, in an embodiment. In a particular implementation, a display, such as display 900, may comprise a dashboard, portal (e.g., web page), and/or other user interface that may allow a user, such as user 410, to access and/or interact with a system to determine a probability of a particular parcel arriving at a particular location by a particular time and/or date. For example, a display, such as display 900, may allow a user, such as user 410, to control, at least in part, operation of a computing device, such as mobile device 300 and/or server computing device 110, for example.

In an embodiment, a display, such as display 900, may be rendered by a computing device, such as mobile device 300, to permit viewing by a user, such as user 410. User 410, for example, may also interact with one or more input devices, such as a touchscreen, for example, of a computing device, such as mobile device 300. Via a user interface, a user, such as user 410, may indicate a particular parcel for which to determine a probability of a successful delivery. For example, a user may provide a tracking number via a user interface. At least in part responsive to a user input, a computing device, such as mobile device 300, for example, may generate one or more probabilities, such as probability values 920, to be displayed to a user. In an embodiment, individual probability values, indicating a probability of a successful delivery (e.g., delivery at a particular location by a particular time and/or date), may be determined and/or displayed for respective candidate transportation routes. For the example depicted in FIG. 9, a particular candidate route may have a probability of 45% (e.g., 45% chance of successful delivery), while another candidate route may have a probability of 55%. A user, for example, may indicate a preferred route, in an embodiment.

In an embodiment, a display, such as display 900, may include an area to display a menu of possible levels and/or classes of shipping services. For example, an area, such as area 910, may display options for a two-day delivery service, an overnight service, and/or an overnight/early morning service, for example. A user may select an option, and a display, such as display 900, may indicate probabilities for one or more particular routes that may be used to accomplish the specified level of service. For the particular example depicted in FIG. 9, for example, a user, such as user 410, may have specified an “overnight” level of service for a parcel originating in Chicago, for example, and destined for Dallas, for example. A display of probabilities, such as display 920, may indicate to a user, such as user 410, risks involved in specifying an overnight level of service given current and/or forecasted weather conditions. A user, such as user 410, may, for example, select a different level of service, may specify a different route, and/or may decline to ship, in an embodiment. Further, in an embodiment, a display, such as display 900, may be updated from time-to-time (e.g., periodically) so that a user, such as user 410, may understand more recent conditions. Of course, claimed subject matter is not limited in scope to the particular characteristics described herein with respect to any particular display.

In an embodiment, a particular parameter indicating whether a particular parcel was delayed due to weather may be calculated and/or otherwise determined. For example, a parameter labeled “was_delayed_weather” may be included in a “Parcel” record, as indicated in example Table 1, below. As depicted in Table 1, a “Parcel” record may include a number of parameters, including, for example, tracking number (tracking_number), shipping date and/or time (ship_date_time), scheduled delivery time and/or date (scheduled_delivery_date_time), actual delivery time and/or date (actual_delivery_date_time), a required intervention parameter (required_intervention), a parameter indicating a delayed delivery (was_delayed), and/or a parameter indicating a delayed delivery due to weather (was_delayed_weather). Of course, claimed subject matter is not limited in scope in these respects.

Example Table 1 further includes a an example parcel activity record “Parcel Activity” including parameters associated with a particular parcel shipping activity and/or event, in an embodiment. Table 1 additionally includes an example weather condition record “Weather” including parameters representative of particular weather observations and/or measurements taken at a particular weather station at a particular date and/or time, for example. As depicted in Table 1, an example “Parcel Activity” record may comprise, for example, various parameters including tracking number (tracking_number), date and/or time (date_time), activity code (activity_code), city (city), state (state), postal code (zip_code), latitude, longitude, closest weather station (closest_station_wban), rounded date and/or time (rounded_date_time), and/or a distance error (station_distance_error). An example “Weather” record may comprise, for example, various parameters including a weather station identifier (wban), date and/or time (date_time), visibility, weather type (weather_type), dry bulb temperature (dry_bulb_celsius), wet bulb temperature (wet_bulb_celsius), dew point (dew_point_celsius), relative humidity (relative_humidity), wind speed (wind_speed), barometric pressue (station_pressure), record type, hourly precipitation (hourly_precip), and/or altimeter, for example. Of course, claimed subject matter is not limited in scope in these respects.

TABLE 1

| Parcel | Parcel Activity | Weather |
|---|---|---|
| (2,308,354 records) | (16,831,080 records) | (12,529,701 records) |
| tracking_number (text) | tracking_number (text) | wban (text) |
| ship_date_time (timestamp) | date_time (timestamp) | date_time (timestamp) |
| scheduled_delivery_date_time (timestamp) | activity_code (text) | visibility (numeric) |
| actual_delivery_date_time (timestamp) | city (text) | weather_type (text) |
| service (text) | state (text) | dry_bulb_celsius (numeric) |
| required_intervention (boolean) | zip_code (text) | wet_bulb_celsius (numeric) |
| was_delayed (boolean) | latitude (numeric) | dew_point_celsius (numeric) |
| was_delayed_weather (boolean) | longitude (numeric) | relative_humidity (numeric) |
| | closest_station_wban (text) | wind_speed (numeric) |
| | rounded_date_time (timestamp) | station_pressure (numeric) |
| | station_distance_error (numeric) | record_type (text) |
| | | hourly_precip (numeric) |
| | | altimeter (numeric) |

In an embodiment, sets of digital content, such as weather content 122 and/or shipping content 124, for example, may be represented as an electronic file having a comma-separated format, for example, generated via SQL, for example. In an embodiment, a training set of content, including historical weather condition content and/or historical shipping activity content, for example, may be substantially randomly sampled from a larger set of content. In an embodiment, a training set may comprise 25% of a larger content set, for example. In an embodiment, an example sampled content set may be stored in a “sample_data” folder, for example. For the purposes of examples explored below, a full content set may not be provided. In an embodiment, parameters imported into a content set, such as content set “R,” may have a structure similar to that depicted above in example Table 1.

With respect to importation of shipping and/or weather content, a content set may comprise zipped CSV content, for example. Such content may be partitioned into three content frames, for example, such as described above in connection with Table 1, in an embodiment. In an embodiment, date and/or time parameters may be converted to a POSIXct type for ease of processing, for example.

In an embodiment, machine learning models may be employed to determine a value, such as a Boolean value, for a “was_weather_delayed” parameter of a “Parcel” record, as discussed above. Example SQL code is provided below for one or more example embodiments. In an embodiment, parameters that may be utilized to determine a value for “was_weather_delayed,” for example, may be included in one or more records, such as one or more “Parcel Activity” and/or “Weather” records. Furthermore, a “was_delayed_weather” parameter may be associated with particular parcels, yet individual parcels may also be associated with multiple parameters in one or more “Parcel Activity” and/or “Weather” records, for example. In an embodiment, “Parcel,” “Parcel Activity,” and/or “Weather” records may be combined into a particular structure within a database, such as database 120. In an embodiment, multiple “Parcel,” “Parcel Activity,” and/or “Weather” records may be grouped together based on a tracking_number parameter. In an embodiment, a mean, maximum, and/or minimum for respective numeric weather observations and/or parameters may be calculated for a particular parcel, for example.

In an embodiment, a content set, such as a combination of weather content and/or shipping content, for example, may be split into a 60% portion for use as a training set (e.g., for neural network models and/or other machine-learning techniques) and/or into a 40% portion for use in testing an implementation. In an embodiment, because 25%, for example, of a full content set may be utilized, an example machine-learning model may be effectively training on 15% of a full content set, testing with 10%, thereby leaving 75% for further verification operations. In circumstances in which a machine-learning model may not operate as intended, a larger training set maybe specified, for example.

In an embodiment, prior to utilization of a particular predictive and/or machine-learning model, an accuracy of a null prediction operation may be calculated. In an example, a training set may yield a confusion matrix depicted in Table 2, below:

TABLE 2
Confusion Matrix

| | F (Pred) | T (Pred) |
|---|---|---|
| F (Actual) | 334,385 | 0 |
| T (Actual) | 2,170 | 0 |

An example null prediction operation may demonstrate an accuracy for a null prediction of 99.35%, a value unlikely to be exceed in some circumstances. In predicting relatively rare events, a null model as a baseline may generally have a relatively higher accuracy. However, a null model may not be useful as a predictive model in a practical implementation. Therefore, a model having a relatively lower accuracy may be beneficial, acknowledging, for example, that trade-offs between false positive and false negative rates may be understood and/or customized to a particular situation. For example, in a financial environment, accepting an actually fraudulent transaction may be relatively much worse than denying an actually non-fraudulent transaction. Therefore, implementing a model having a lower accuracy but higher predictive ability with respect to actually fraudulent transactions may make practical sense.

In an embodiment, a visualization comprising a correlation plot may be generated, for example, via an example SQL command, as follows:
corrplot(cor(parcel_train[sapply(parcel_train, is.numeric)]),
   method=“circle”)

A few patterns in an example correlation plot that may be generated via example SQL command provided above may be observed. Because for a particular example content may comprise ten variables repeated three times, except once as a mean, once as a max, and/or once as a min, similar patterns may generally repeat in a 3×3 grid. In an example correlation plot generated via the example SQL command provided above, there may exist some correlation between visibility and/or relative_humidity parameters, for example. However, a greater correlation may be observed between dry_bulb_celsius, wet_bulb_celsius, and dew_point_celsius values, for example. In an embodiment, two of the three variables in mean, max, and min variable groups may be ignored in at least some circumstances, for example.

In an embodiment, a machine-learning technique (e.g. parcel activity predictive model), such as to determine a probability of a particular parcel being successfully delivered by a particular date and/or time at a particular destination location, for example, may include a multiple linear regression model, for example. A model utilizing multiple variables (except a few that may be eliminated during a variable correlation analysis, such as discussed above, for example) may be implemented. In an embodiment, one or more parameters may be eliminated, such as one at a time, for example, until relatively significant parameters remain. In an embodiment, a predictive model may be implemented using the following example code:
glm(was_delayed_weather˜
   visibility_mean+dry_bulb_celsius_mean+relative_humidity_mean+wind_speed_mean+station_pressure_mean+visibility_max+relative_humidity_max+hourly_precip_max+visibility_min+dry_bulb_celsius_min+relative_humidity_min+wind_speed_min+station_pressure_min,
data=parcel_train,
family=“binomial”)

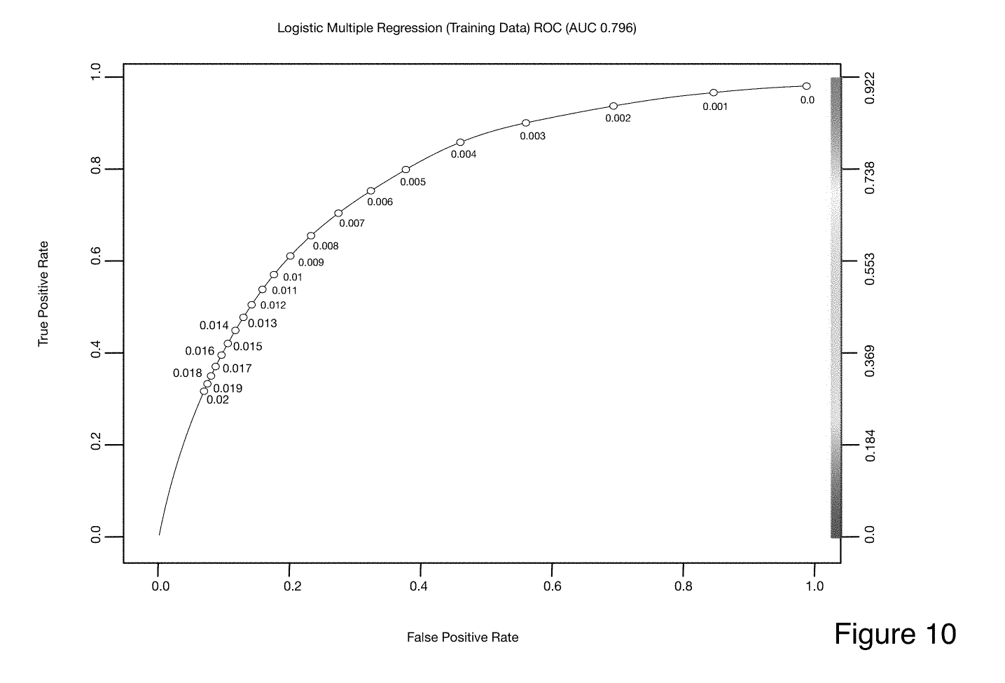

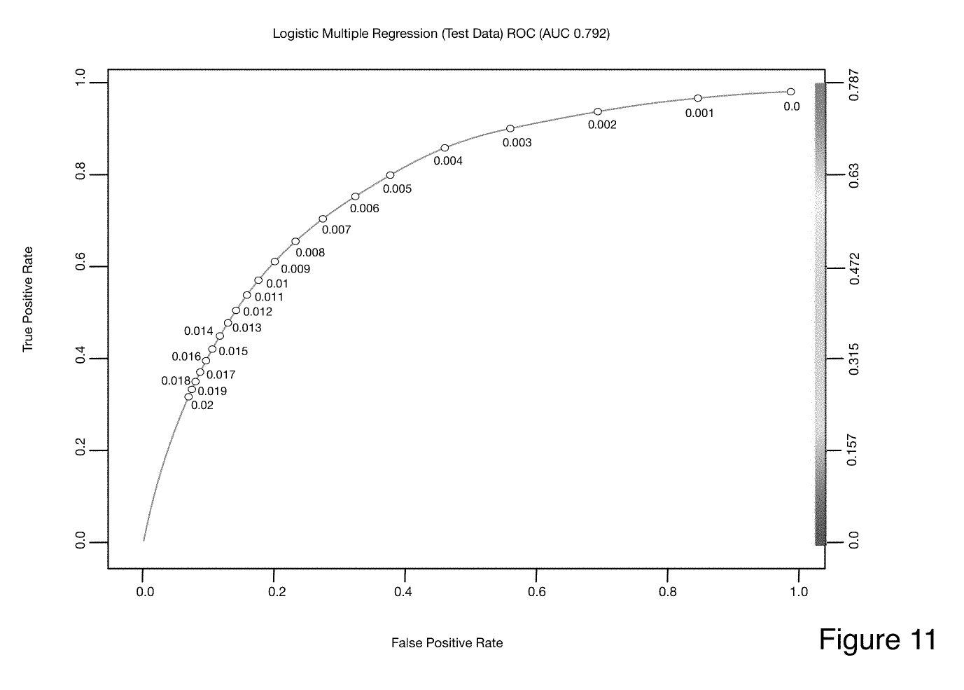

To analyze an example linear model, a receiver operating characteristic (ROC) curve for training and/or for test content may be extracted, and/or an area under curve (AUC) may be calculated for training and/or test content, as seen in FIG. 10 and/or FIG. 11. Calculating a ROC curve for training content may allow for exploration of a possibility of content being over-fit. It is clear that an example model yielded predictive capability. In an embodiment, specifying a threshold of 0.020, a confusion matrix, depicted in Table 3, below, may yield an accuracy of 94.19%.

TABLE 3
Confusion Matrix for linear regression, threshold = 0.020

| | F (Pred) | T (Pred) |
|---|---|---|
| F (Actual) | 211,154 | 12,038 |
| T (Actual) | 1,008 | 470 |

Another example machine-learning technique (e.g., predictive model) may comprise a decision tree, which may be implemented at least in part by executing the following example code, in an embodiment:
rpart(
was_delayed_weather ˜
   visibility_mean+dry_bulb_celsius_mean+relative_humidity_mean+wind_speed_mean+station_pressure_mean+hourly_precip_mean+visibility_max+dry_bulb_celsius_max+relative_humidity_max+wind_speed_max+station_pressure_max+hourly_precip_max+visibility_min+dry_bulb_celsius_min+relative_humidity_min+wind_speed_min+station_pressure_min,
method=“class”,
control=rpart.control(cp=0.0001, minsplit=40),
data=parcel_train)

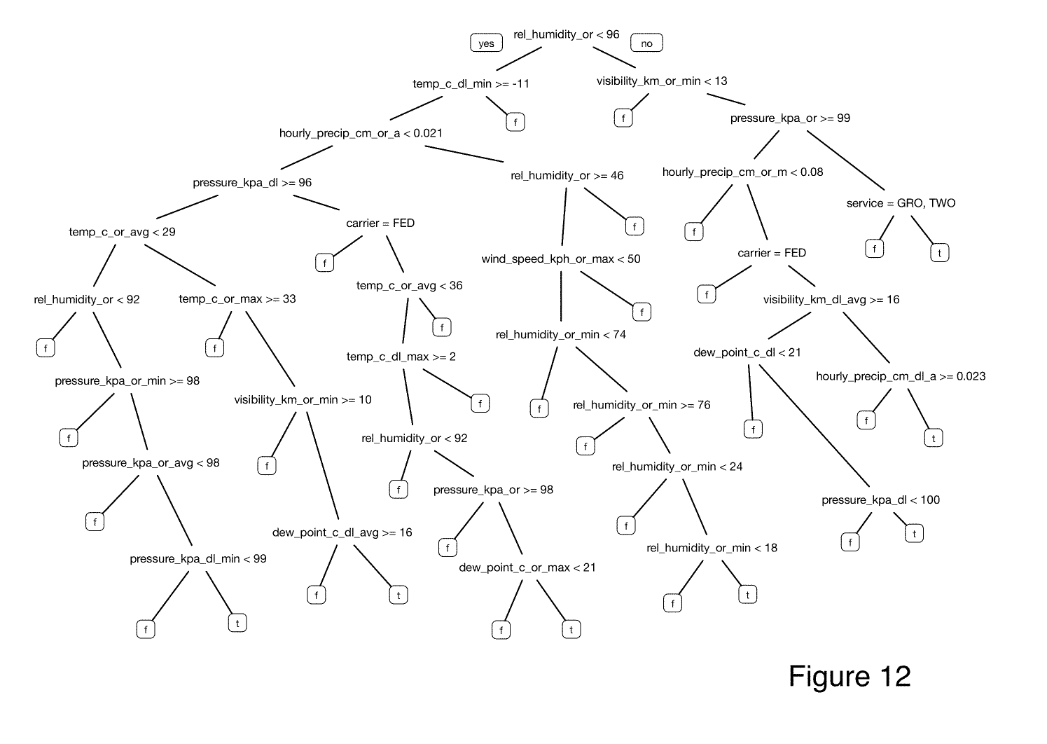

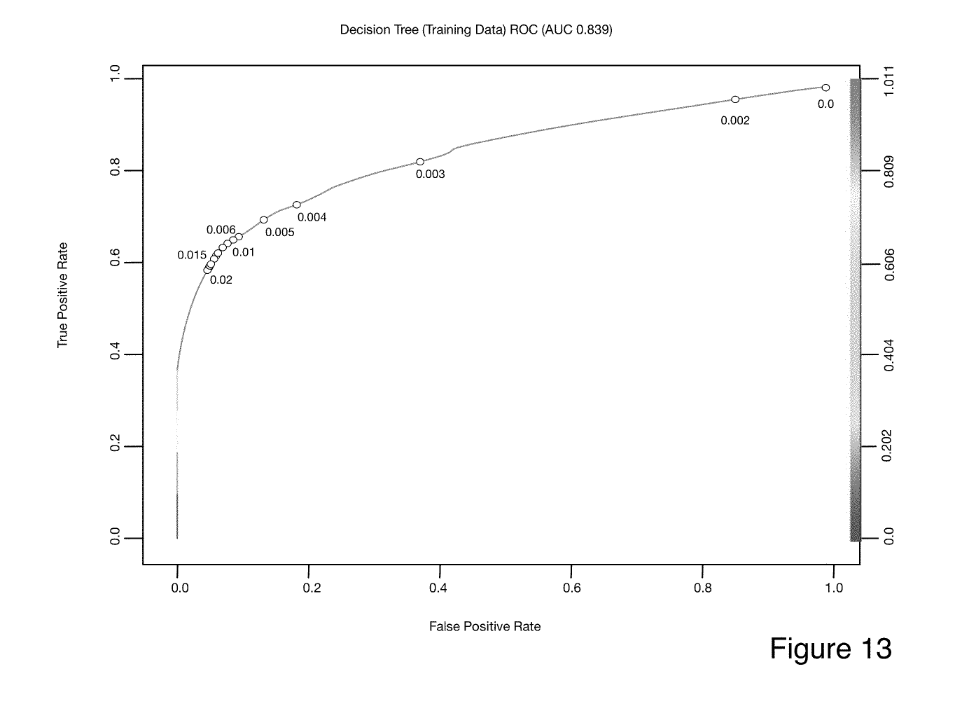

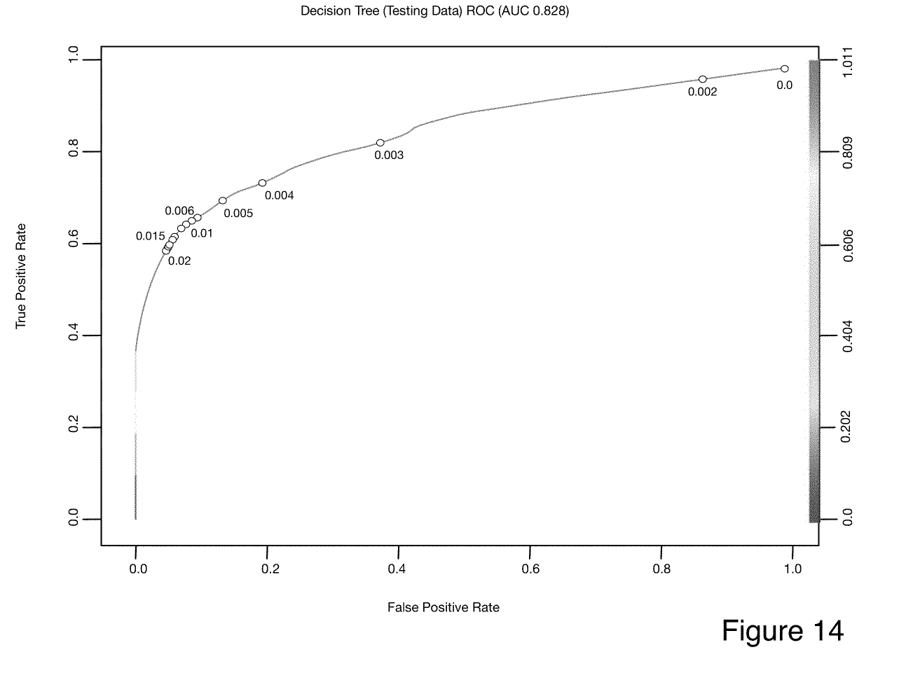

Parameters passed to a control parameter may be determined at least in part by sweeping a two-dimensional parameter space and calculating an AUC at individual points. FIG. 12 depicts an example decision tree, and FIG. 13 and/or FIG. 14 depict AUC curves for an example model against training content and/or testing content. An improvement in this model versus a logistic multiple regression may be observed, at least in these examples. However, a display of an example decision tree shows that such an implementation may be relatively complicated, in an embodiment.

To reduce complexity of a decision tree and/or decrease chances that a model is over-fit, an example SQL command, as follows, may be implemented:
parcel_tree_pruned<-
   prune(parcel_tree, cp=parcel_tree$cptable
      [which.min(parcel_tree$cptable[,“xerror”]),“CP”])

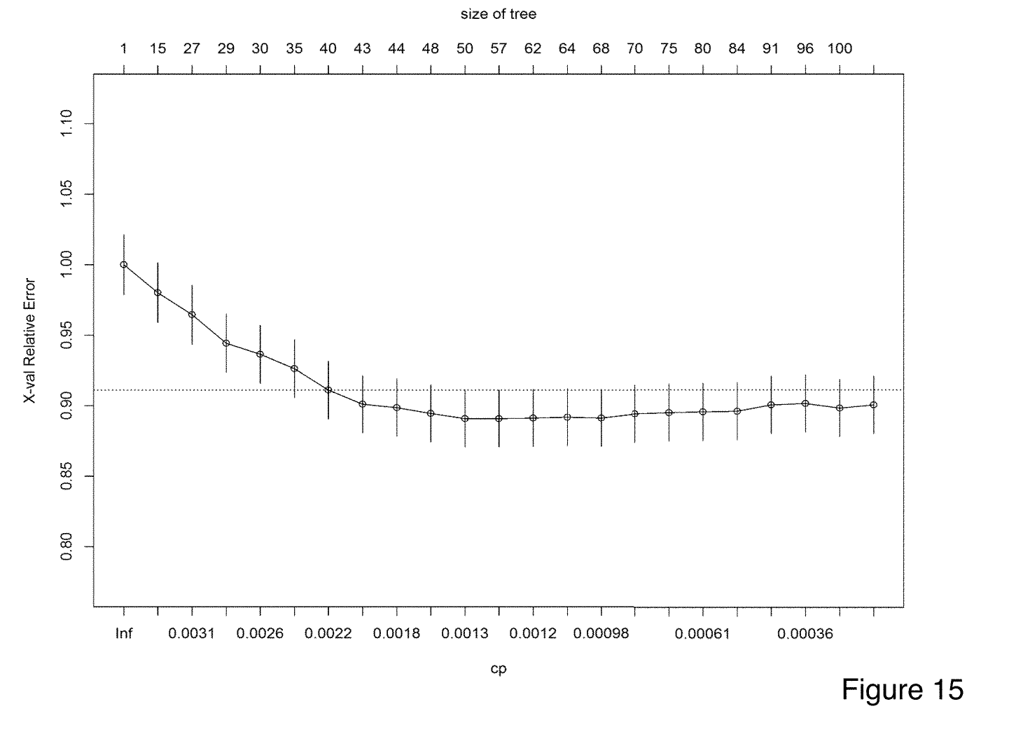

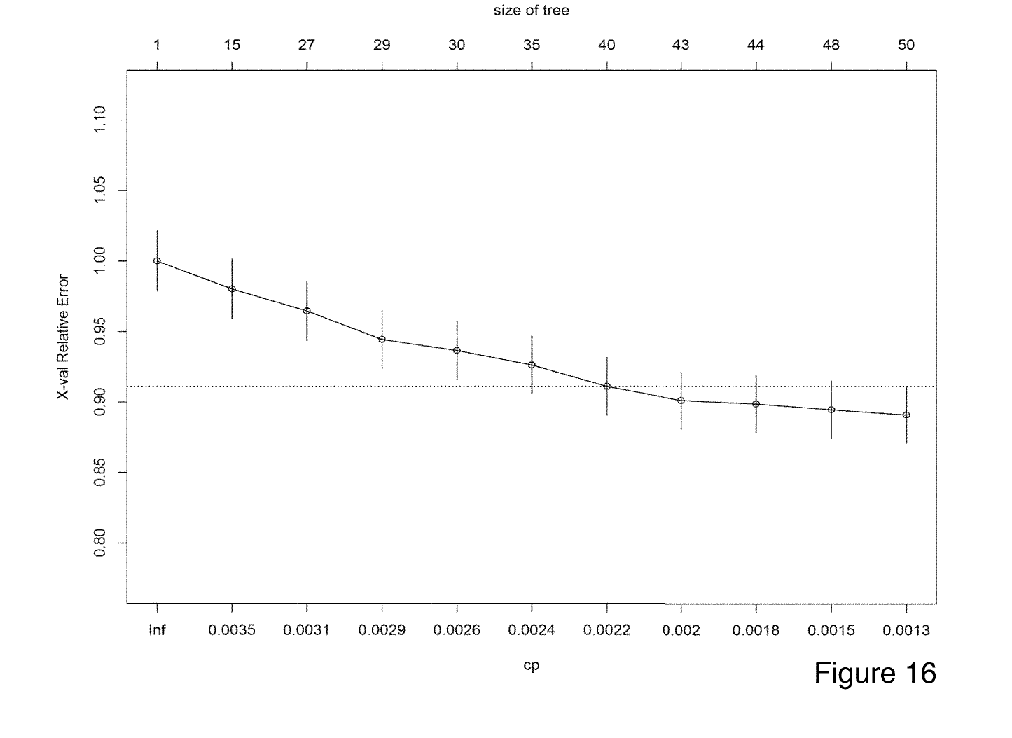

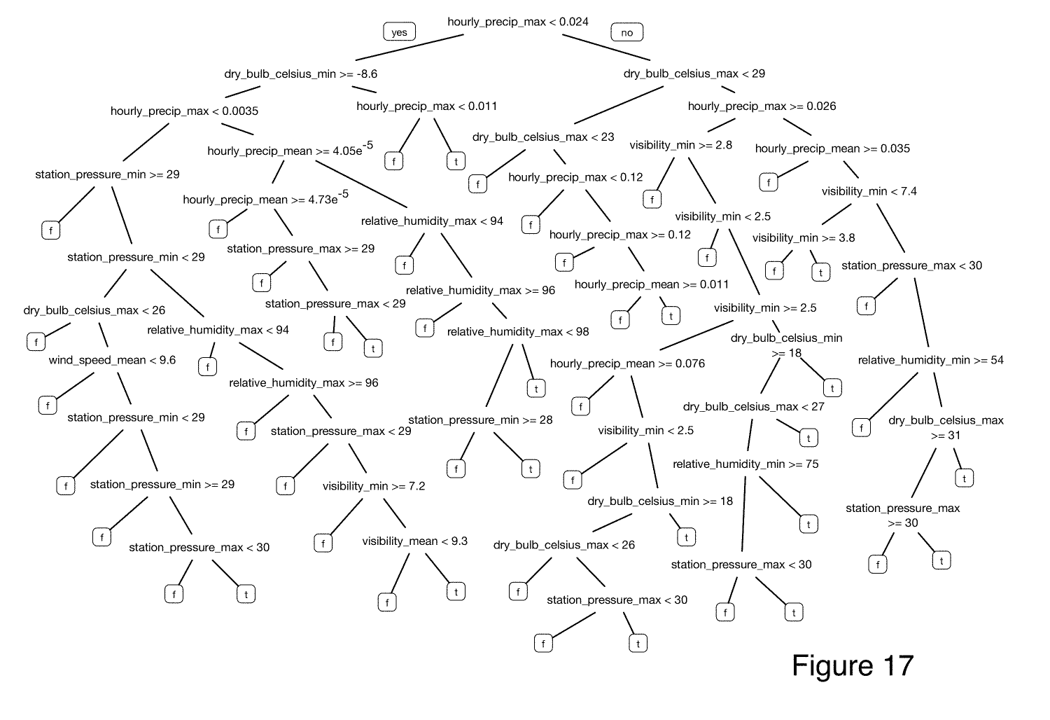

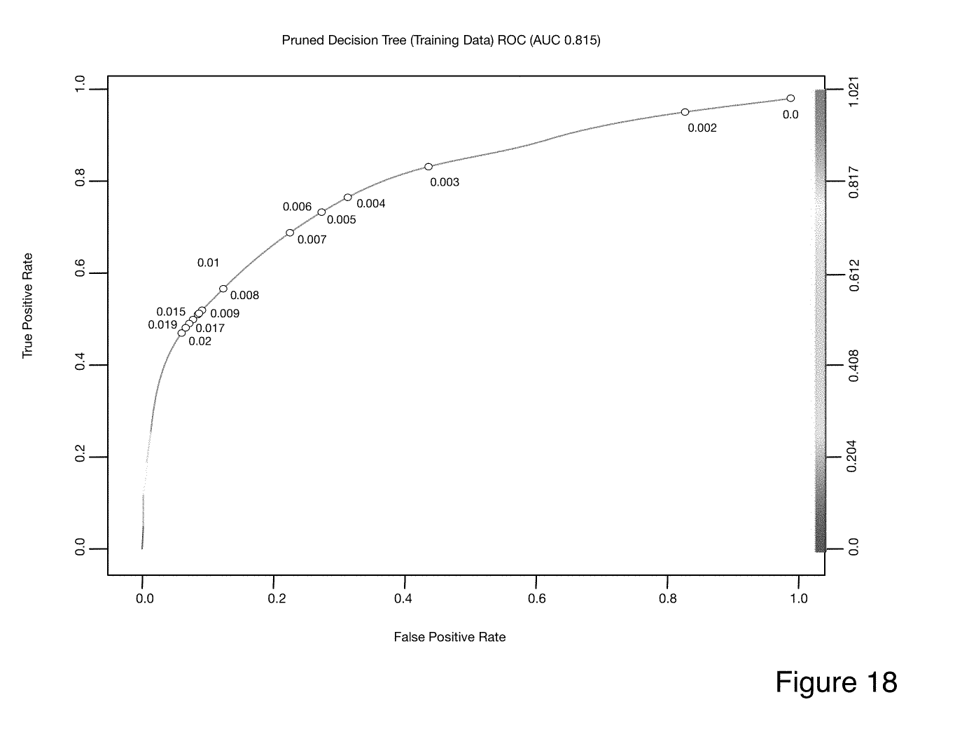

FIG. 15 and/or FIG. 16 depict complexity parameter plots for individual example decision tree implementations, such as before and after pruning. Further, FIGS. 17, 18, and/or 19 depict illustrations of example plots similar to those discussed above in connection with FIGS. 12, 13, and/or 14, with utilization of a pruned decision tree. A pruned tree may be relatively less complex, in an embodiment. Although reduced complexity may come at an expense of some accuracy, utilization of a less complicated tree may be beneficial. A confusion matrix using pruned content and a threshold value of 0.020, as shown in Table 4, yields an accuracy of 95.30%.

TABLE 4
Confusion Matrix for linear regression, threshold = 0.020

| | F (Pred) | T (Pred) |
|---|---|---|
| F (Actual) | 211,154 | 12,038 |
| T (Actual) | 1,008 | 470 |

An additional algorithm for machine-learning, for example, may be implemented via execution of an example RandomForest SQL command, as provided below, for example.

randomForest(
was_delayed_weather ˜visibility_mean+dry_bulb_celsius_mean+relative_humidity_mean+wind_speed_mean+station_pressure_mean+hourly_precip_mean+visibility_max+dry_bulb_celsius_max+relative_humidity_max+wind_speed_max+station_pressure_max+hourly_precip_max+visibility_min+dry_bulb_celsius_min+relative_humidity_min+wind_speed_min+station_pressure_min,
   data=parcel_train, nodesize=20, ntree=500)

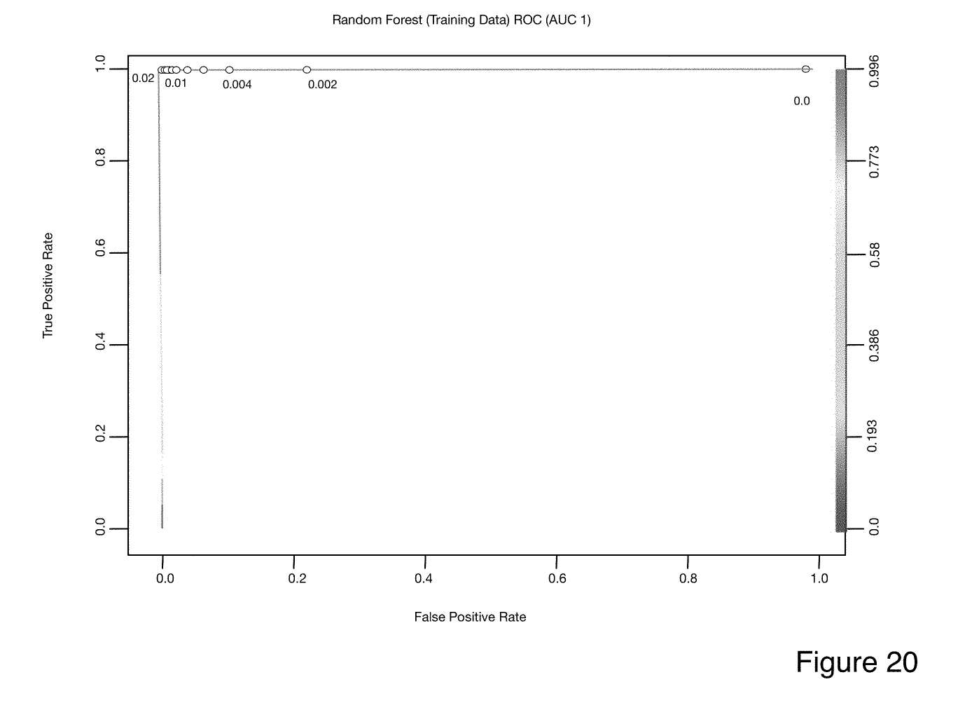

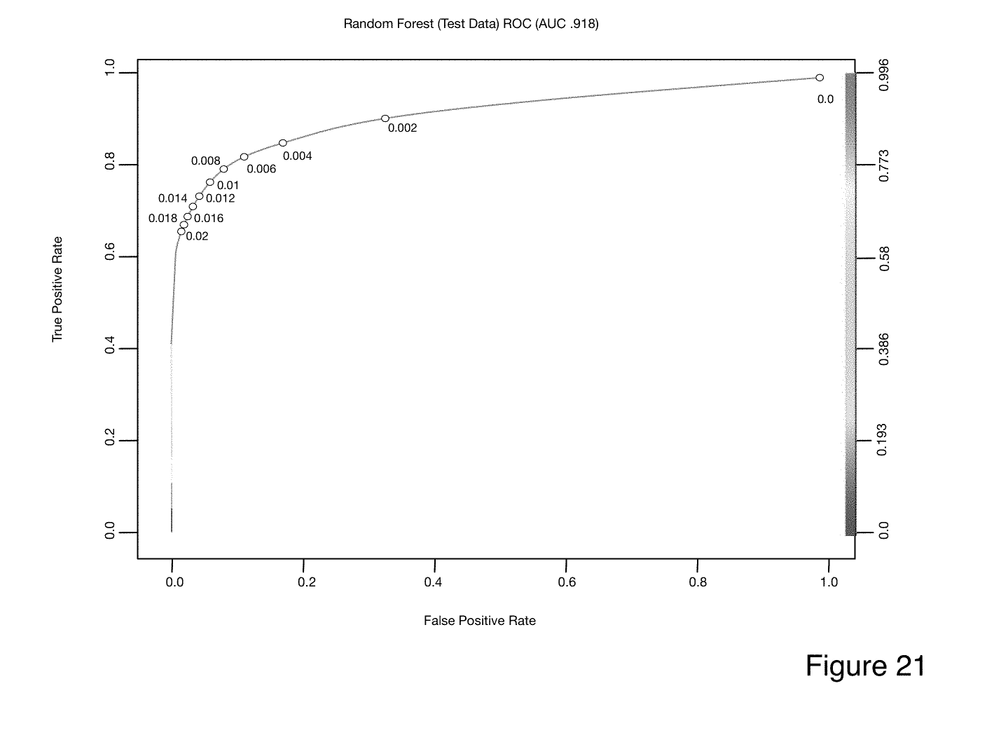

Again, for example, parameters may be chosen based on at least some parameter sweeping, for example. Parameters may also be chosen, for example, to discourage overfitting. FIG. 20 depicts an example ROC curve for a training content set, and/or FIG. 21 depicts an example ROC curve for a test content set, in an embodiment.

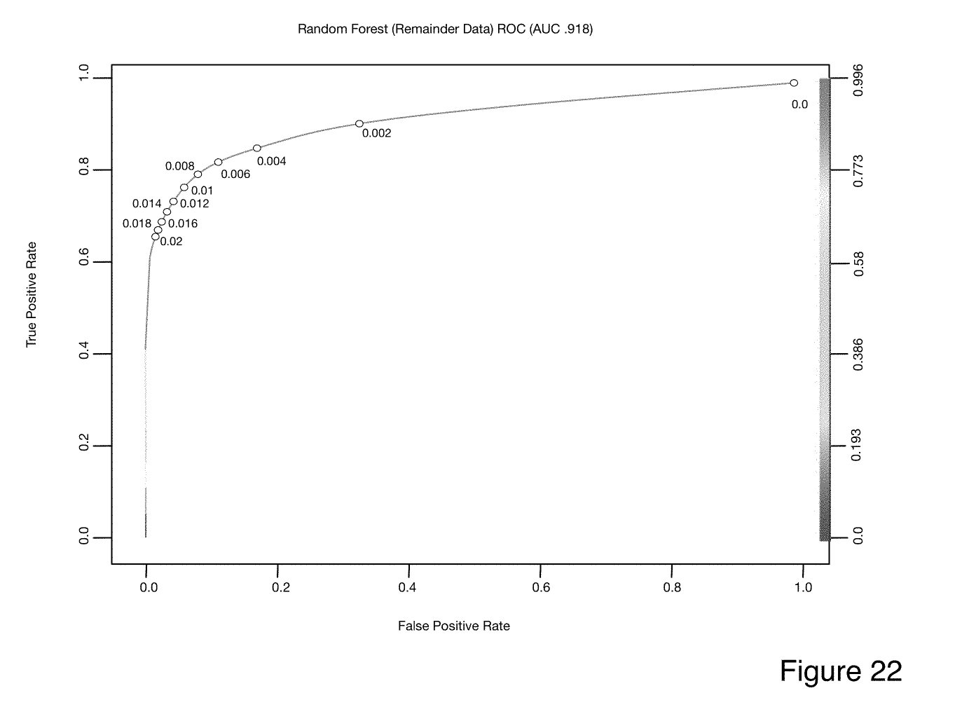

Observing an example ROC curve for training content depicted in FIG. 20, it may appear that either a mistake has been made, and/or that perhaps a random forest algorithm may have been utilized incorrectly, and/or utilized parameters that may lead to a radical overfitting of the content (e.g., AUC for ROC curve on training content rounds up to 1.000). Even so, an example model may provide a reasonable fit to test content. As an experiment, it was determined to run a remaining 75% of a content set that had been reserved via an example model. A resulting ROC curve is depicted in FIG. 22. An example confusion matrix with threshold at 0.020 is shown below in connection with Table 5:

TABLE 5
Confusion Matrix for linear regression,
threshold = 0.020, remainder content set

| | F (Pred) | T (Pred) |
|---|---|---|
| F (Actual) | 1,641,348 | 35,548 |
| T (Actual) | 3,342 | 7,590 |

An example confusion matrix depicted in Table 5, above, shows an accuracy of 97.70%, which may represent an improved result as compared with other example models discussed herein. In an embodiment, a random forest model may be observed to fit test and/or remainder content sets reasonably well, and/or not to an unrealistic degree. In a particular implementation, a random forest model may provide predictions with improved reliability.

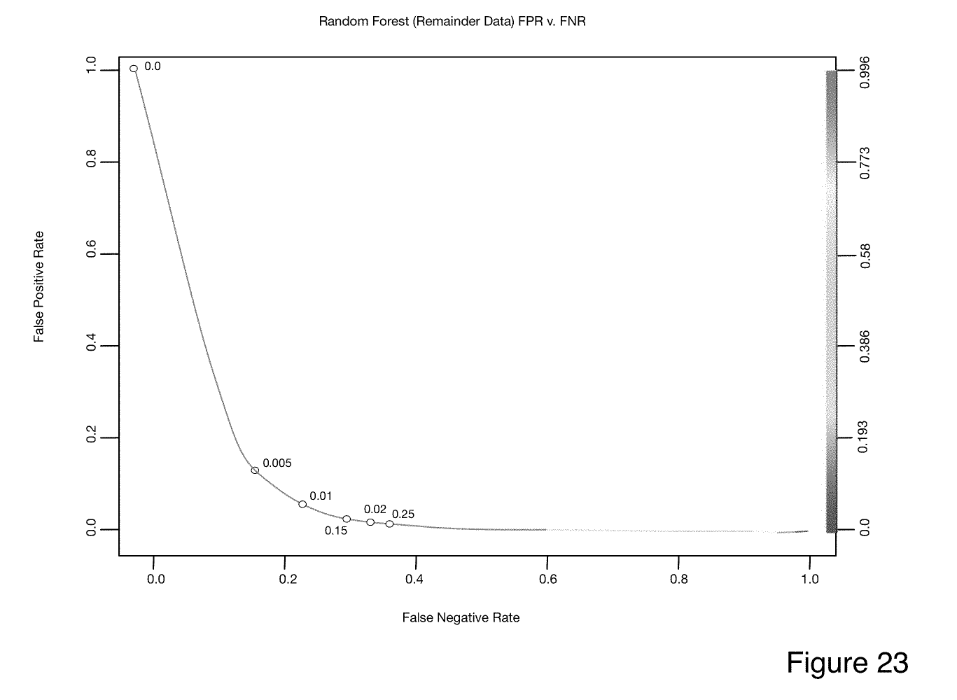

In embodiments, it may be desirable to achieve a desirable and/or beneficial balance between minimizing a false positive rate vs. a false negative rate. In an embodiment, it may be relatively more important to reduce a false negative rate. A plot of a false positive rate vs. a false negative rate can be seen in FIG. 23. An example plot depicted in FIG. 23, for example, illustrates that 0.020 may be a reasonable value to choose for the threshold. However, while example embodiments may include prediction of a binary outcome (e.g., a determination as to whether a particular parcel will arrive at a particular destination and/or intermediate location by a particular time and/or date), other embodiments may provide continuous and/or substantially continuous prediction, which may not involve specifying a threshold value, for example.

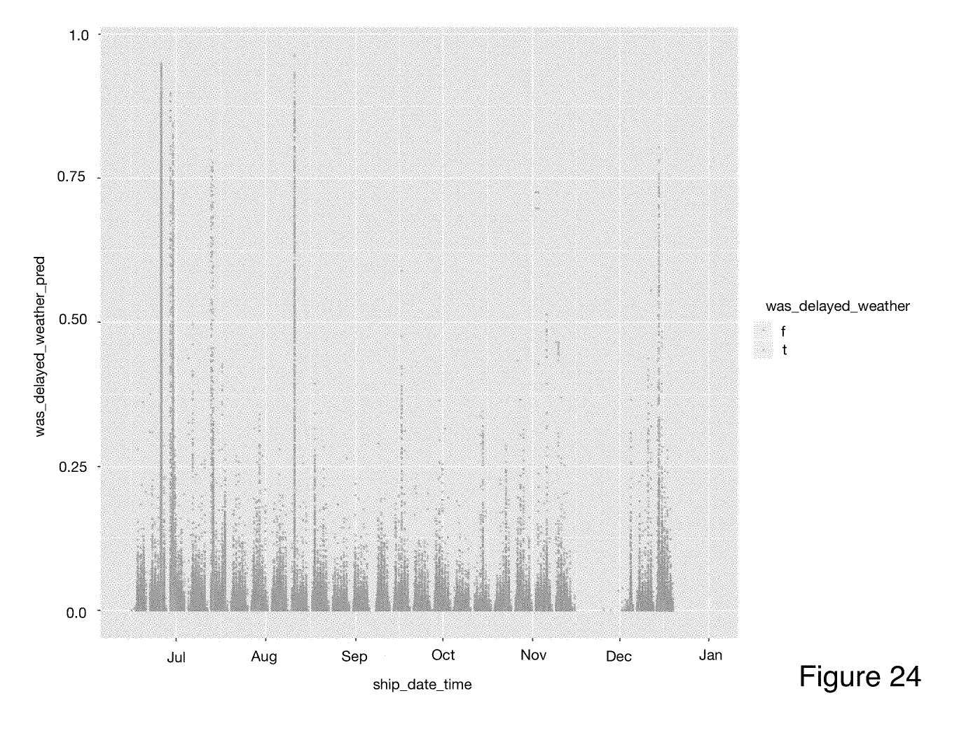

To help visualize a predicted and/or modeled outcome, a predicted delay due to weather parameter (which may range from 0.0 to 1.0, for example, and which may comprise an output of a random forest algorithm) may be plotted vs. a parcel manifest date. In an example display, such as a plot depicted, for example, in FIG. 24, scatterplot points may be colored based at least in part on whether or not the parcel was actually late due to weather. Example SQL code for generating a visualization, such as a scatterplot, may include:

ggplot(content=parcel_remainder[with(parcel_remainder,

order(was_delayed_weather)),],
aes(x=ship_date_time,
   y=was_delayed_weather_pred,
   color=was_delayed_weather,
   alpha=was_delayed_weather))+scale_alpha_discrete(range=c(0.50, 0.50))+geom_point(size=0.5)+xlim(as.POSIXct(“2015-06-15 00:00:00”), as.POSIXct(“2015-12-31 23:59:59”))

It may be an improvement, in an embodiment, to display points with blue dots of an example scatterplot disproportionately towards the top of a plot and points with red dots disproportionately toward the bottom of the plot, which may generally be observed in an example scatterplot depicted in FIG. 24. In an embodiment, incoming content may be sorted based on a was_delayed_weather parameter so TRUE values, fewer in number, may show up on top of a scatterplot. This may have an effect of making them easier to see, but may could obscure FALSE values underneath. Partial transparency within a scatterplot, for example, may be beneficial, in an embodiment.

Interesting observations may be made from an example plot of FIG. 24. First, while a plot depicted in FIG. 24 may appear a little like a histogram, it is not. For example, a “height” of the plot doesn't necessarily have anything to do with a number of parcels shipped on a particular day. Second, a weekly pattern of shipping carriers may be made relatively obvious. Third, it may appear that for an example plot a few weeks of content may be missing from late November, for whatever reason. Fourth, there appear to be “spikes” in a plot of FIG. 24, which may be puzzling at first, but seem as though they may correspond to relatively large regional weather events, such as a widespread or particularly intense storm events, for example, which may have resulted in a disproportionate number of parcels to be late.

Although machine-learning models for some embodiments may utilize sampled and/or historical parcel activity records covering part of a year, a full year of content (or even spanning multiple years) may be more beneficial. For example, weather occurring during all seasons over the course of a year may be taken into consideration, in an embodiment. In a particular implementation, a period from June through December of a particular year may cover enough weather patterns and/or events to make good first approximation, however.

In an embodiment, machine-learning techniques may utilize forecasted weather content, rather and/or in addition to historical weather content. This may add an additional layer of uncertainty in some circumstances. Various embodiments of machine-learning models may be reevaluated based at least in part on weather forecast content. It may also be beneficial to study and/or reevaluate embodiments employing an example random forest model. Further, although several particular example models for predicting parcel shipping activity are discussed herein, many more example types may be employed in other embodiments. Furthermore, embodiments may utilize a combination of algorithms.

Example machine-learning techniques described herein may be of immediate beneficial use to various entities, such as, for example, specialty pharmacies. Such use may include display of a predictive factor for parcels, such as classifying their risk of being delayed due to weather based on available forecast content, for example. Performance of a given predictive model may be monitored and/or further content, such as weather and/or shipping content, may be fed back into various example algorithms, thereby potentially strengthening a predictive ability.

In an embodiment, a random forest model may yield relatively higher accuracy, as shown in Table 6, below:

TABLE 6
Accuracy by Algorithm, threshold - 0.020

| | Null | Multiple Linear | Decision | Random |
|---|---|---|---|---|
| | Prediction | Regression | Tree | Forest |
| Accuracy | 99.35% | 94.19% | 95.30% | 97.70% |

However, in an embodiment, selecting a different threshold value may allow a developed random forest algorithm to achieve a relatively higher accuracy than a null prediction model, but may come at an expense of a relatively higher false negative rate. Further exploration of threshold values may yield improved results in some circumstances, for example.

In an embodiment, a method of executing computer instructions on at least one computing device without further human interaction in which the at least one computing device includes at least one processor and at least one memory may include fetching computer instructions from the at least one memory of the at least one computing device for execution on the at least one processor of the at least one computing device. A method may further include executing the fetched computer instructions on the at least one processor of the at least one computing device, and storing in the at least one memory of the at least one computing device any results of having executed the fetched computer instructions on the at least one processor of the at least one computing device. In an embodiment, the computer instructions to be executed may include instructions for determining a probability of a particular parcel arriving at a particular location by a particular time and/or date. In an embodiment, executing fetched instructions may further include obtaining, at at least one computing device, signals and/or states representative of one or more weather condition records and/or signals and/or states representative of one or more parcel shipping activity records, and/or may include identifying, via one or more machine-learning operations executed by the at least one processor, one or more correlations between one or more parameters of one or more weather condition records and one or more parameters of the one or more parcel shipping activity records.

In an embodiment, computer instructions to be executed may also include instructions for determining a probability of a particular parcel arriving at a particular location by a particular time and/or date based, at least in part, on one or more identified correlations between one or more parameters of one or more weather condition records and one or more parameters of the one or more parcel shipping activity records, and generating content for display representative of a determined probability of a particular parcel arriving at a particular location by the particular time and/or date.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present patent application, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, Md., 21050-2747), but may include other aspects, such as the Hadoop distributed file system (HDFS) (available from the Apache Software Foundation, 1901 Munsey Drive, Forrest Hill, Md., 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present patent application, use of the term “Hadoop” is intended to include versions, presently known and/or to be later developed.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as of one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

In the context of the present patent application, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present patent application that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present patent application, may comprise a service that organizes stored digital content, such as, for example, text, images, video, etc., through the use of hypermedia, for example. It is noted that a network, such as the Internet and/or Web, may be employed to store electronic files and/or electronic documents.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the term “Web site” and/or similar terms refer to Web pages that are associated electronically to form a particular collection thereof. Also, in the context of the present patent application, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. Parameters may, for example, comprise signals and/or states representative of measurements, observations, characteristics, conditions, status, etc. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, or 4G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Content GSM Environment (EDGE), 3GPP Long Term Evolution (LTE), LTE Advanced, Wideband Code Division Multiple Access (WCDMA), Bluetooth, ultra-wideband (UWB), 802.11b/g/n, and/or the like. A wireless network may include virtually any type of now known and/or to be developed wireless communication mechanism and/or wireless communications protocol by which signals may be communicated between devices, between networks, within a network, and/or the like, including the foregoing, of course.

In one example embodiment, as shown in FIG. 25, a system embodiment may comprise a local network (e.g., device 2504 and medium 2540) and/or another type of network, such as a computing and/or communications network. For purposes of illustration, therefore, FIG. 25 shows an embodiment 2500 of a system that may be employed to implement either type or both types of networks. Network 2508 may comprise one or more network connections, links, processes, services, applications, and/or resources to facilitate and/or support communications, such as an exchange of communication signals, for example, between a computing device, such as 2502, and another computing device, such as 2506, which may, for example, comprise one or more client computing devices and/or one or more server computing device. By way of example, but not limitation, network 2508 may comprise wireless and/or wired communication links, telephone and/or telecommunications systems, Wi-Fi networks, Wi-MAX networks, the Internet, a local area network (LAN), a wide area network (WAN), or any combinations thereof.

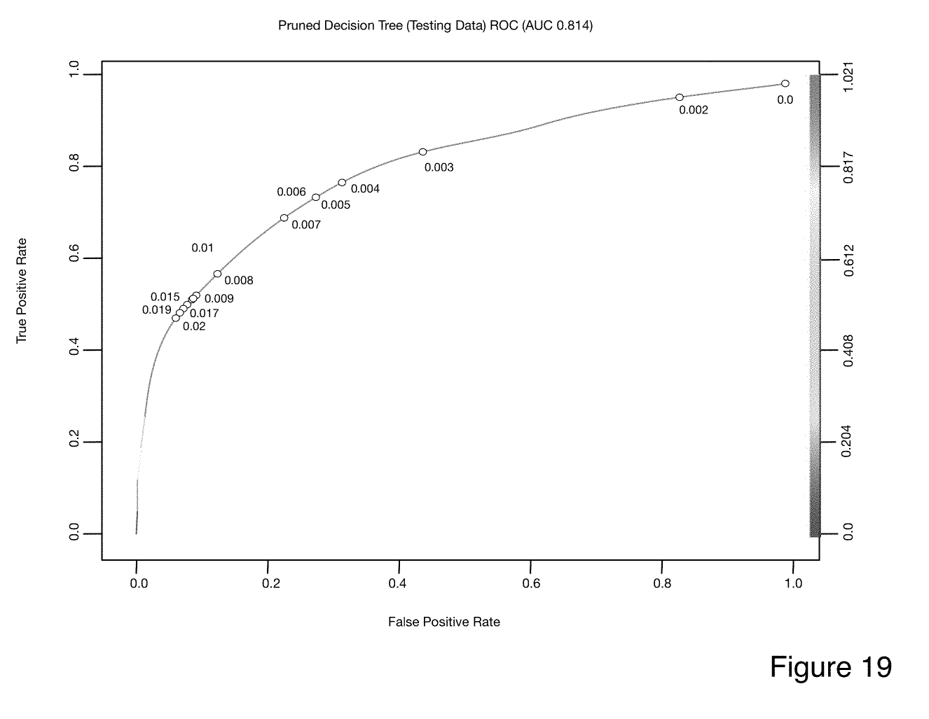

Example devices in FIG. 25 may comprise features, for example, of a client computing device and/or a server computing device, in an embodiment. It is further noted that the term computing device, in general, whether employed as a client and/or as a server, or otherwise, refers at least to a processor and a memory connected by a communication bus. Likewise, in the context of the present patent application at least, this is understood to refer to sufficient structure within the meaning of 35 USC § 112 (f) so that it is specifically intended that 35 USC § 112 (f) not be implicated by use of the term “computing device” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 1-24 and in the text associated with the foregoing figure(s) of the present patent application.

Referring now to FIG. 25, in an embodiment, first and third devices 2502 and 2506 may be capable of rendering a graphical user interface (GUI) for a network device and/or a computing device, for example, so that a user-operator may engage in system use. Device 2504 may potentially serve a similar function in this illustration. Likewise, in FIG. 25, computing device 2502 (‘first device’ in figure) may interface with computing device 2404 (‘second device’ in figure), which may, for example, also comprise features of a client computing device and/or a server computing device, in an embodiment. Processor (e.g., processing device) 2520 and memory 2522, which may comprise primary memory 2524 and secondary memory 2526, may communicate by way of a communication bus 2515, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 2504, as depicted in FIG. 25, is merely one example, and claimed subject matter is not limited in scope to this particular example.

For one or more embodiments, a computing device may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced content rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, Flickr, and/or Google+, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 25, computing device 2502 may provide one or more sources of executable computer instructions in the form physical states and/or signals (e.g., stored in memory states), for example. Computing device 2502 may communicate with computing device 2504 by way of a network connection, such as via network 208, for example. As previously mentioned, a connection, while physical, may not necessarily be tangible. Although computing device 2504 of FIG. 25 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 2522 may comprise any non-transitory storage mechanism. Memory 2522 may comprise, for example, primary memory 2524 and secondary memory 2526, additional memory circuits, mechanisms, or combinations thereof may be used. Memory 2522 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 2522 may be utilized to store a program of executable computer instructions. For example, processor 2520 may fetch executable instructions from memory and proceed to execute the fetched instructions. Memory 2522 may also comprise a memory controller for accessing device readable-medium 2540 that may carry and/or make accessible digital content, which may include code, and/or instructions, for example, executable by processor 2520 and/or some other device, such as a controller, as one example, capable of executing computer instructions, for example. Under direction of processor 2520, a non-transitory memory, such as memory cells storing physical states (e.g., memory states), comprising, for example, a program of executable computer instructions, may be executed by processor 2520 and able to generate signals to be communicated via a network, for example, as previously described. Generated signals may also be stored in memory, also previously suggested.

Memory 2522 may store electronic files and/or electronic documents, such as relating to one or more users, and may also comprise a computer-readable medium that may carry and/or make accessible content, including code and/or instructions, for example, executable by processor 2520 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. 3The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 25, processor 2520 may comprise one or more circuits, such as digital circuits, to perform at least a portion of a computing procedure and/or process. By way of example, but not limitation, processor 2520 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 2520 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 25 also illustrates device 2504 as including a component 2532 operable with input/output devices, for example, so that signals and/or states may be appropriately communicated between devices, such as device 2504 and an input device and/or device 2504 and an output device. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method of executing computer instructions on at least one computing device without further human interaction in which the at least one computing device includes at least one processor and at least one memory, comprising:
fetching computer instructions from the at least one memory of the at least one computing device for execution on the at least one processor of the at least one computing device;
executing the fetched computer instructions on the at least one processor of the at least one computing device; and
storing in the at least one memory of the at least one computing device any results of having executed the fetched computer instructions on the at least one processor of the at least one computing device;
wherein the computer instructions to be executed comprise instructions for determining a probability of a particular parcel arriving at a particular location by a particular time and/or date;
wherein the executing the fetched instructions further comprises:
obtaining, at the at least one computing device, signals and/or states representative of one or more weather condition records and/or signals and/or states representative of one or more parcel shipping activity records;
identifying, via one or more machine-learning operations executed by the at least one processor, one or more correlations between one or more parameters of the one or more weather condition records and one or more parameters of the one or more parcel shipping activity records;
determining the probability of the particular parcel arriving at the particular location by the particular time and/or date based, at least in part, on the one or more identified correlations between the one or more parameters of the one or more weather condition records and the one or more parameters of the one or more parcel shipping activity records; and
generating content for display representative of the determined probability of the particular parcel arriving at the particular location by the particular time and/or date.

2. The method of claim 1, wherein the executing the fetched instructions further comprises communicating one or more signal packets representative of the content for display between the at least one computing device and a client computing device.

3. The method of claim 1, wherein the one or more weather condition records comprises one or more historical weather condition records.

4. The method of claim 1, wherein the determining the probability of the particular parcel arriving at the particular location by the particular time and/or date is further based, at least in part, on one or more forecasted weather condition records.

5. The method of claim 1, wherein the determining the probability of the particular parcel arriving at the particular location by the particular time and/or date is further based, at least in part, on one or more shipping infrastructure characteristic parameters.

6. The method of claim 1, wherein the one or more machine-learning operations includes one or more operations to perform a random forest machine-learning algorithm.

7. The method of claim 1, wherein the one or more machine-learning operations includes one or more operations to perform a decision-tree machine-learning algorithm.

8. The method of claim 1, wherein the identifying the one or more correlations comprises determining one or more groups of particular weather condition records and/or particular parcel shipping activity records based, at least in part, on one or more location parameters of the one or more weather condition records and/or the one or more parcel shipping activity records.

9. The method of claim 1, wherein the identifying the one or more correlations comprises determining one or more groups of particular weather condition records and/or particular parcel shipping activity records based, at least in part, on one or more time and/or date parameters of the one or more weather condition records and/or the one or more parcel shipping activity records.

10. The method of claim 1, wherein the obtaining the signals and/or states representative of the one or more weather condition records comprises obtaining the one or more weather condition records from a meteorological organization via signal packet communications over a network.

11. The method of claim 1, wherein the obtaining the signals and/or states representative of the one or more parcel shipping activity records comprises obtaining the one or more parcel shipping activity records from at least one commercial shipping entity computing device via signal packet communications over a network.

12. An apparatus, comprising:
at least one computing device;
the at least one computing device to include at least one processor and at least one memory;
the at least one computing device to execute computer instructions on the at least one processor without further human intervention;
the computer instructions to be executed having been fetched from the at least one memory for execution on the at least one processor, and the at least one computing device to store in the at least one memory of the at least one computing device any results to be generated from the execution on the at least one processor of the to be executed computer instructions;
the computer instructions to be executed to comprise instructions to determine a probability of a particular parcel arriving at a particular location by a particular time and/or date;
wherein the instructions to be executed as a result of execution to:
obtain, at the at least one computing device, signals and/or states representative of one or more weather condition records and/or signals and/or states representative of one or more parcel shipping activity records;
identify, via one or more machine-learning operations, one or more correlations between one or more parameters of the one or more weather condition records and one or more parameters of the one or more parcel shipping activity records
determine the probability of the particular parcel arriving at the particular location by the particular time and/or date based, at least in part, on the one or more identified correlations between the one or more parameters of the one or more weather condition records and the one or more parameters of the one or more parcel shipping activity records; and
generate content for display representative of the determined probability of the particular parcel arriving at the particular location by the particular time and/or date.

13. The apparatus of claim 12, wherein the computer instructions to be executed include instructions to initiate communication of one or more signal packets representative of the content for display between the at least one computing device and a client computing device.

14. The apparatus of claim 12, wherein the one or more weather condition records comprises one or more historical weather condition records.

15. The apparatus of claim 12, wherein the computer instructions to be executed to comprise instructions to determine the probability of the particular parcel arriving at the particular location by the particular time and/or date based, at least in part, on one or more forecasted weather condition records.

16. The apparatus of claim 12, wherein the computer instructions to be executed to comprise instructions to determine the probability of the particular parcel arriving at the particular location by the particular time and/or date based, at least in part, on one or more shipping infrastructure characteristic parameters.

17. The apparatus of claim 12, wherein the one or more machine-learning operations includes one or more operations to perform a random forest machine-learning algorithm or a decision-tree machine-learning algorithm or a combination thereof.

18. The apparatus of claim 12, wherein, to identify the one or more correlations, the computer instructions to be executed to comprise instructions to determine one or more groups of particular weather condition records and/or particular parcel shipping activity records based, at least in part, on one or more location parameters of the one or more weather condition records and/or the one or more parcel shipping activity records.

19. The apparatus of claim 12, wherein, to identify the one or more correlations, the computer instructions to be executed to comprise instructions to determine one or more groups of particular weather condition records and/or particular parcel shipping activity records based, at least in part, on one or more time and/or date parameters of the one or more weather condition records and/or the one or more parcel shipping activity records.

20. The method of claim 1, wherein the computer instructions to be executed to comprise instructions to obtain the signals and/or states representative of the one or more weather condition records from a meteorological organization via signal packet communications over a network and/or to obtain the signals and/or states representative of the one or more parcel shipping activity records from at least one commercial shipping entity computing device via signal packet communications over a network.
